(19) United States
(12) Patent Application Publication
(10) Pub. No.: US 2026/0220903 A1
(43) Pub. Date: Jul. 30, 2026

(54) AVATAR GENERATION

(71) Applicant: QUALCOMM Incorporated, San Diego, CA (US)

(72) Inventor: Mustafa KESKIN, San Diego, CA (US)

(21) Appl. No.: 19/041,767

(22) Filed: Jan. 30, 2025

(51) Int. Cl. G06T 19/20; G06N 3/08; G06T 13/40

(52) U.S. Cl. CPC G06T 19/20; G06N 3/08; G06T 13/40

(57) ABSTRACT

Systems and techniques are described for avatar generation. For example, a computing device can generate, using a generator of a machine learning model based on a noise input, a plurality of candidate avatars. The computing device can modify, based on at least one of user preferences of a user for features of an avatar or popularity of available avatars, an initial dataset of avatars to generate a modified dataset of avatars. The computing device can compare, using a discriminator of the machine learning model, each candidate avatar of the plurality of candidate avatars with avatars in the modified dataset of avatars. The computing device can determine, using the discriminator based on the comparing, whether each candidate avatar of the plurality of candidate avatars belongs in the modified dataset of avatars.

### FIELD

The present disclosure generally relates to extended reality (XR) systems. For example, aspects of the present disclosure relate to the generation of avatars (and in some cases skins for avatars) based on user priority and popularity weights.

### BACKGROUND

An XR (e.g., virtual reality, augmented reality, mixed reality) system can provide a user with a virtual experience by immersing the user in a completely virtual environment (made up of virtual content) and/or can provide the user with an augmented or mixed reality experience by combining a real-world or physical environment with a virtual environment.

One example use case for XR content that provides virtual, augmented, or mixed reality to users is to present a user with a “metaverse” experience. The metaverse is essentially a virtual universe that includes one or more three-dimensional (3D) virtual worlds. For example, a metaverse virtual environment may allow a user to virtually interact with other users (e.g., in a social setting, in a virtual meeting, etc.), to virtually shop for goods, services, property, or other item, to play computer games, and/or to experience other services.

In some cases, a user (or a character) may be represented in a virtual environment (e.g., a metaverse virtual environment) as a virtual representation of the user (or the character), sometimes referred to as an avatar, a skin, or a game character. In any virtual environment, it can be beneficial for a system to be able to generate user-defined personalized avatars and skins.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described for avatar generation. In some aspects, an apparatus for generating avatars is provided. The apparatus includes at least one memory and at least one processor coupled to the at least one memory and configured to: generate, using a generator based on a noise input, a plurality of candidate avatars; modify, based on at least one of user preferences of a user for features of an avatar or popularity of available avatars, an initial dataset of avatars to generate a modified dataset of avatars; compare, using a discriminator of a machine learning model, each candidate avatar of the plurality of candidate avatars with avatars in the modified dataset of avatars; and determine, using the discriminator based on the comparing, whether each candidate avatar of the plurality of candidate avatars belongs in the modified dataset of avatars.

In some aspects, a method for generating avatars is provided. The method includes: generating, by a generator based on a noise input, a plurality of candidate avatars; modifying, based on at least one of user preferences of a user for features of an avatar or popularity of available avatars, an initial dataset of avatars to generate a modified dataset of avatars; comparing, by a discriminator of a machine learning model, each candidate avatar of the plurality of candidate avatars with avatars in the modified dataset of avatars; and determining, by the discriminator based on the comparing, whether each candidate avatar of the plurality of candidate avatars belongs in the modified dataset of avatars.

In some aspects, a non-transitory computer-readable medium is provided having stored thereon instructions that, when executed by at least one processor, cause the at least one processor to: generate, using a generator based on a noise input, a plurality of candidate avatars; modify, based on at least one of user preferences of a user for features of an avatar or popularity of available avatars, an initial dataset of avatars to generate a modified dataset of avatars; compare, using a discriminator of a machine learning model, each candidate avatar of the plurality of candidate avatars with avatars in the modified dataset of avatars; and determine, using the discriminator based on the comparing, whether each candidate avatar of the plurality of candidate avatars belongs in the modified dataset of avatars.

In some aspects, an apparatus for generating avatars is provided. The apparatus includes: means for generating, by a generator based on a noise input, a plurality of candidate avatars; means for modifying, based on at least one of user preferences of a user for features of an avatar or popularity of available avatars, an initial dataset of avatars to generate a modified dataset of avatars; means for comparing, by a discriminator of a machine learning model, each candidate avatar of the plurality of candidate avatars with avatars in the modified dataset of avatars; and means for determining, by the discriminator based on the comparing, whether each candidate avatar of the plurality of candidate avatars belongs in the modified dataset of avatars.

Some aspects include a device having a processor (or multiple processors) configured to perform one or more operations of any of the methods summarized above. In some cases, the processor(s) can include a neural processing unit (NPU), a neural signal processor (NSP), a digital signal processor (DSP), a graphics processing unit (GPU), a central processing unit (CPU), any combination thereof, and/or other processor(s). Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

In some aspects, one or more of the apparatuses described herein is, is part of, and/or includes an extended reality (XR) device or system (e.g., a virtual reality (VR) device, an augmented reality (AR) device, or a mixed reality (MR) device), a mobile device (e.g., a mobile telephone or other mobile device), a wearable device, a wireless communication device, a camera, a personal computer, a laptop computer, a vehicle or a computing device or component of a vehicle, a server computer or server device (e.g., an edge or cloud-based server, a personal computer acting as a server device, a mobile device such as a mobile phone acting as a server device, an XR device acting as a server device, a vehicle acting as a server device, a network router, or other device acting as a server device), another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensor.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein May be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a diagram illustrating an example of an extended reality (XR) system, in accordance with some aspects of the disclosure.

FIG. 2 is a diagram illustrating an example of a three-dimensional (3D) collaborative virtual environment, in accordance with some aspects of the disclosure.

FIG. 3 is an image with a virtual representation (an avatar) of a user, in accordance with some aspects of the disclosure.

FIG. 4 is a diagram illustrating another example of an XR system, in accordance with some aspects of the disclosure.

FIG. 5 is a diagram illustrating an example configuration of a client device, in accordance with some aspects of the disclosure.

FIG. 6 is a diagram illustrating an example of a normal map, an albedo map, and a specular reflection map, in accordance with some aspects of the disclosure.

FIG. 7 is a diagram illustrating an example of a system for generation of images, in accordance with some aspects of the disclosure.

FIG. 8 is a diagram illustrating an example of a system for generation of skins and avatars using user (owner) historical usage, in accordance with some aspects of the disclosure.

FIG. 9 is a diagram illustrating an example of a system for generation of skins and avatars using user priority and community popularity, in accordance with some aspects of the disclosure.

FIG. 10 is a diagram illustrating an example of a system for generation of skins and avatars using owner prompts (e.g., user priority), in accordance with some aspects of the disclosure.

FIG. 11 is a block diagram illustrating an example of a deep learning neural network, in accordance with some aspects of the disclosure.

FIG. 12 is a block diagram of an example transformer, in accordance with some aspects of the disclosure.

FIG. 13 is a flow diagram illustrating an example of a process for avatar generation, in accordance with some aspects of the disclosure.

FIG. 14 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

As noted previously, an extended reality (XR) system or device can provide a user with an XR experience by presenting virtual content to the user (e.g., for a completely immersive experience) and/or can combine a view of a real-world or physical environment with a display of a virtual environment (made up of virtual content). The real-world environment can include real-world objects (also referred to as physical objects), such as people, vehicles, buildings, tables, chairs, and/or other real-world or physical objects. As used herein, the terms XR system and XR device are used interchangeably. Examples of XR systems or devices include head-mounted displays (HMDs), smart glasses (e.g., AR glasses, MR glasses, etc.), among others.

XR systems can include virtual reality (VR) systems facilitating interactions with VR environments, augmented reality (AR) systems facilitating interactions with AR environments, mixed reality (MR) systems facilitating interactions with MR environments, and/or other XR systems. For instance, VR provides a complete immersive experience in a three-dimensional (3D) computer-generated VR environment or video depicting a virtual version of a real-world environment. VR content can include VR video in some cases, which can be captured and rendered at very high quality, potentially providing a truly immersive virtual reality experience. Virtual reality applications can include gaming, training, education, sports video, online shopping, among others. VR content can be rendered and displayed using a VR system or device, such as a VR HMD or other VR headset, which fully covers a user's eyes during a VR experience.

AR is a technology that provides virtual or computer-generated content (referred to as AR content) over the user's view of a physical, real-world scene or environment. AR content can include any virtual content, such as video, images, graphic content, location data (e.g., global positioning system (GPS) data or other location data), sounds, any combination thereof, and/or other augmented content. An AR system is designed to enhance (or augment), rather than to replace, a person's current perception of reality. For example, a user can see a real stationary or moving physical object through an AR device display, but the user's visual perception of the physical object may be augmented or enhanced by a virtual image of that object (e.g., a real-world car replaced by a virtual image of a DeLorean), by AR content added to the physical object (e.g., virtual wings added to a live animal), by AR content displayed relative to the physical object (e.g., informational virtual content displayed near a sign on a building, a virtual coffee cup virtually anchored to (e.g., placed on top of) a real-world table in one or more images, etc.), and/or by displaying other types of AR content. Various types of AR systems can be used for gaming, entertainment, and/or other applications.

MR technologies can combine aspects of VR and AR to provide an immersive experience for a user. For example, in an MR environment, real-world and computer-generated objects can interact (e.g., a real person can interact with a virtual person as if the virtual person were a real person).

An XR environment can be interacted with in a seemingly real or physical way. As a user experiencing an XR environment (e.g., an immersive VR environment) moves in the real world, rendered virtual content (e.g., images rendered in a virtual environment in a VR experience) also changes, giving the user the perception that the user is moving within the XR environment. For example, a user can turn left or right, look up or down, and/or move forwards or backwards, thus changing the user's point of view of the XR environment. The XR content presented to the user can change accordingly, so that the user's experience in the XR environment is as seamless as it would be in the real world.

In some cases, an XR system can match the relative pose and movement of objects and devices in the physical world. For example, an XR system can use tracking information to calculate the relative pose of devices, objects, and/or features of the real-world environment in order to match the relative position and movement of the devices, objects, and/or the real-world environment. In some examples, the XR system can use the pose and movement of one or more devices, objects, and/or the real-world environment to render content relative to the real-world environment in a convincing manner. The relative pose information can be used to match virtual content with the user's perceived motion and the spatio-temporal state of the devices, objects, and real-world environment. In some cases, an XR system can track parts of the user (e.g., a hand and/or fingertips of a user) to allow the user to interact with items of virtual content.

XR systems or devices can facilitate interaction with different types of XR environments (e.g., a user can use an XR system or device to interact with an XR environment). One example of an XR environment is a metaverse virtual environment. A user may virtually interact with other users (e.g., in a social setting, in a virtual meeting, etc.), virtually shop for items (e.g., goods, services, property, etc.), to play computer games, and/or to experience other services in a metaverse virtual environment. In one illustrative example, an XR system may provide a 3D collaborative virtual environment for a group of users. The users may interact with one another via virtual representations of the users in the virtual environment. The users may visually, audibly, haptically, or otherwise experience the virtual environment while interacting with virtual representations of the other users.

A virtual representation of a user or a character (e.g., a game-based character, a movie-based character, or a book-based character) may be used to represent the user or the character in various different environments or applications (e.g., a virtual environment, a gaming environment, a social media application, etc.). A virtual representation of a user or a character is also referred to herein as an avatar, a skin, or a game character.

Avatars and skins are very popular in virtual reality (e.g., VR, XR, and MR), gaming, and professional sports. However, currently, there are typically no mechanisms that allow for user-defined personalization of the avatars and skins. Although there are some instances that do allow for some personalization of avatars and skins, these systems are mainly controlled by gaming platforms as opposed to the user's own preferences as well as community popularity.

As such, improved systems and techniques for generation of skins and avatars using user priority and community popularity can be beneficial.

In one or more aspects of the present disclosure, systems, apparatuses, methods (also referred to as processes), and computer-readable media (collectively referred to herein as “systems and techniques”) are described herein that provide solutions for the generation of skins and avatars using user priority and popularity weights.

Various aspects relate generally to wireless communications. Some aspects more specifically relate to systems and techniques that provide solutions for generation of user-defined personalized skins and avatars. In one or more examples, these solutions can employ a generative artificial intelligence (GenAI) framework. In some examples, within this framework, a generator can produce images (e.g., fake images) from random noise, and a discriminator can compare the generated images (e.g., fake images) with real images. Training of the discriminator and, then, training of the generator can be performed. In one or more examples, the systems and techniques employ, for the generation of the skins and avatars, user (owner) defined prioritization and/or preferences, community popularity, and/or user (owner) historical usage based discriminator and generator loss modifications.

In one or more aspects, during operation of a method for generating an avatar, a generator can generate, based on a noise input, a plurality of candidate avatars. One or more processors an modify, based on user preferences of a user for features of an avatar and/or popularity of available avatars, an initial dataset of avatars to generate a modified dataset of avatars. A discriminator of a machine learning model can compare each candidate avatar of the plurality of candidate avatars with avatars in the modified dataset of avatars. The discriminator can determine, based on the comparing, whether each candidate avatar of the plurality of candidate avatars belongs in the modified dataset of avatars.

In one or more examples, the discriminator can generate, based on the comparing, for each candidate avatar of the plurality of candidate avatars a respective probability associated with belonging in the modified dataset of avatars. In some examples, the noise input is based on random noise.

In one or more examples, the discriminator can be trained, based on the modified dataset of avatars, to determine whether each candidate avatar of the plurality of candidate avatars belongs in the modified dataset of avatars. During the training of the discriminator, the discriminator can generate a discriminator loss based on an accuracy of the discriminator to determine whether each candidate avatar of the plurality of candidate avatars belongs in the modified dataset of avatar. One or more processors can modify, based on historical usage of avatars by the user, the discriminator loss to generate a modified discriminator loss. The neural network weights of the discriminator can be tuned based on the modified discriminator loss.

In some examples, the generator can be trained, based on the modified dataset of avatars, to generate the plurality of candidate avatars to belong in the modified dataset of avatars. During the training of the generator, the generator can generate a generator loss based on an ability of the generator to generate the plurality of candidate avatars to belong in the modified dataset of avatars. One or more processors can modify, based on historical usage of avatars by the user, the generator loss to generate a modified generator loss. The neural network weights of the generator can be tuned based on the modified generator loss.

In one or more examples, the user preferences can be based on images associated with the user and/or social media posts associated with the user. In some examples, the user preferences for features of the avatar can include a type of clothing, a color of the clothing, a type of hair, a color of the hair, one or more facial features, an attitude, and/or a behavior. In one or more examples, the user preferences can be based on prompt-based weighting for user priority. In some examples, one or more processors can select, based on determining a candidate avatar of the plurality of candidate avatars belongs in the modified dataset of avatars, the candidate avatars for use by the user.

In one or more examples, the generator and the discriminator can be in a generative adversarial network (GAN). In some examples, the machine learning model can be a neural network.

Particular aspects of the subject matter described in this disclosure can be implemented to realize one or more of the following potential advantages. In one or more examples, the systems and techniques can provide a benefit of allowing for generation highly personalized avatars and skins, where the personalization is user defined.

Additional aspects of the present disclosure are described in more detail below. Various aspects of the systems and techniques described herein will be discussed below with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

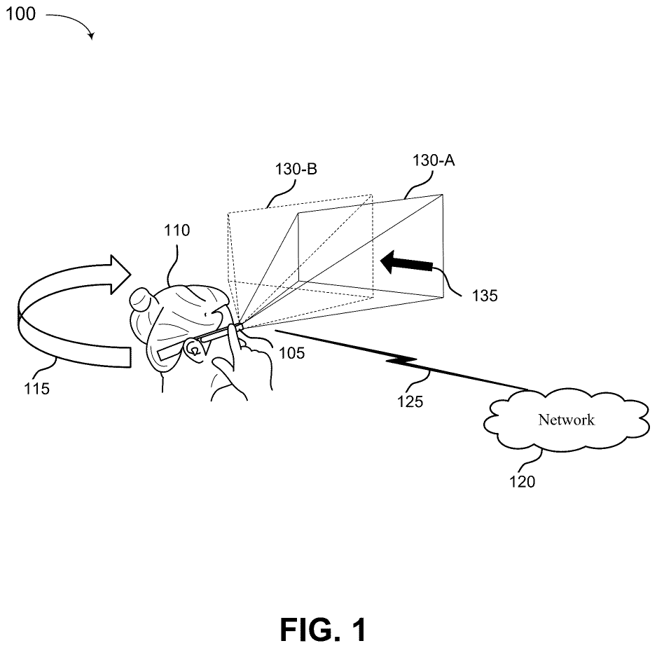

FIG. 1 illustrates an example of an extended reality system 100. As shown, the extended reality system 100 includes a device 105, a network 120, and a communication link 125. In some cases, the device 105 may be an extended reality (XR) device, which may generally implement aspects of extended reality, including virtual reality (VR), augmented reality (AR), mixed reality (MR), etc. Systems including a device 105, a network 120, or other elements in extended reality system 100 may be referred to as extended reality systems.

The device 105 may overlay virtual objects with real-world objects in a view 130. For example, the view 130 may generally refer to visual input to a user 110 via the device 105, a display generated by the device 105, a configuration of virtual objects generated by the device 105, etc. For example, view 130-A may refer to visible real-world objects (also referred to as physical objects) and visible virtual objects, overlaid on or coexisting with the real-world objects, at some initial time. View 130-B may refer to visible real-world objects and visible virtual objects, overlaid on or coexisting with the real-world objects, at some later time. Positional differences in real-world objects (e.g., and thus overlaid virtual objects) may arise from view 130-A shifting to view 130-B at 135 due to head motion 115. In another example, view 130-A may refer to a completely virtual environment or scene at the initial time and view 130-B may refer to the virtual environment or scene at the later time.

Generally, device 105 may generate, display, project, etc. virtual objects and/or a virtual environment to be viewed by a user 110 (e.g., where virtual objects and/or a portion of the virtual environment may be displayed based on user 110 head pose prediction in accordance with the techniques described herein). In some examples, the device 105 may include a transparent surface (e.g., optical glass) such that virtual objects may be displayed on the transparent surface to overlay virtual objects on real word objects viewed through the transparent surface. Additionally or alternatively, the device 105 may project virtual objects onto the real-world environment. In some cases, the device 105 may include a camera and may display both real-world objects (e.g., as frames or images captured by the camera) and virtual objects overlaid on displayed real-world objects. In various examples, device 105 may include aspects of a virtual reality headset, smart glasses, a live feed video camera, a GPU, one or more sensors (e.g., such as one or more IMUs, image sensors, microphones, etc.), one or more output devices (e.g., such as speakers, display, smart glass, etc.), etc.

In some cases, head motion 115 may include user 110 head rotations, translational head movement, etc. The device 105 may update the view 130 of the user 110 according to the head motion 115. For example, the device 105 may display view 130-A for the user 110 before the head motion 115. In some cases, after the head motion 115, the device 105 may display view 130-B to the user 110. The extended reality system (e.g., device 105) may render or update the virtual objects and/or other portions of the virtual environment for display as the view 130-A shifts to view 130-B.

In some cases, the extended reality system 100 may provide various types of virtual experiences, such as a three-dimensional (3D) gaming experiences, social media experiences, collaborative virtual environment for a group of users (e.g., including the user 110), among others. While some examples provided herein apply to 3D collaborative virtual environments, the systems and techniques described herein apply to any type of virtual environment or experience in which a virtual representation (or avatar) can be used to represent a user or participant of the virtual environment/experience.

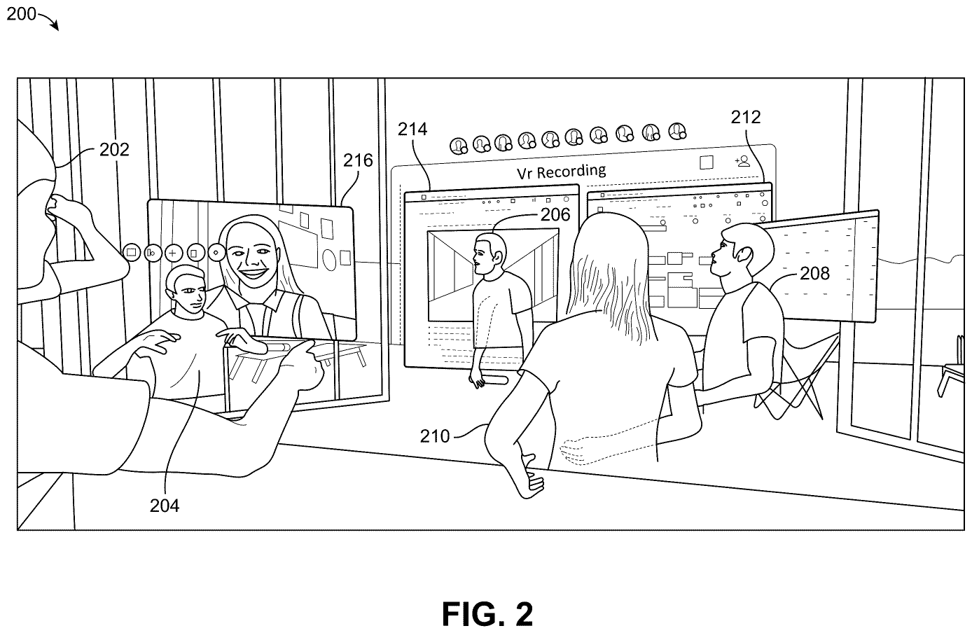

FIG. 2 is a diagram illustrating an example of a 3D collaborative virtual environment 200 in which various users interact with one another in a virtual session via virtual representations (or avatars) of the users in the virtual environment 200. The virtual representations include including a virtual representation 202 of a first user, a virtual representation 204 of a second user, a virtual representation 206 of a third user, a virtual representation 208 of a fourth user, and a virtual representation 210 of a fifth user. Other background information of the virtual environment 200 is also shown, including a virtual calendar 212, a virtual web page 214, and a virtual video conference interface 216. The users may visually, audibly, haptically, or otherwise experience the virtual environment from each user's perspective while interacting with the virtual representations of the other users. For example, the virtual environment 200 is shown from the perspective of the first user (represented by the virtual representation 202).

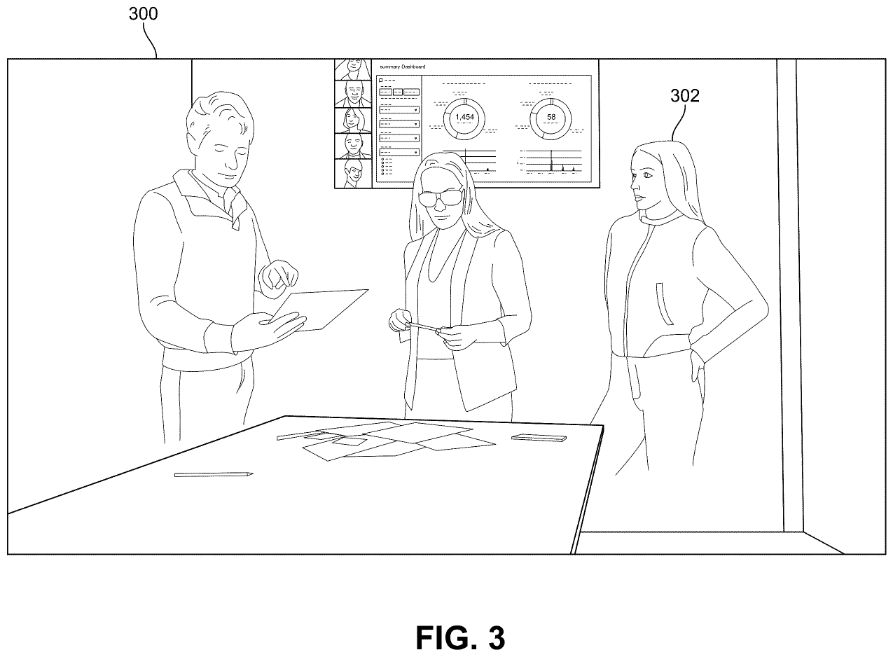

FIG. 3 is an image 300 illustrating an example of virtual representations of various users, including a virtual representation 302 of one of the users. For instance, the virtual representation 302 may be used in the 3D collaborative virtual environment 200 of FIG. 2.

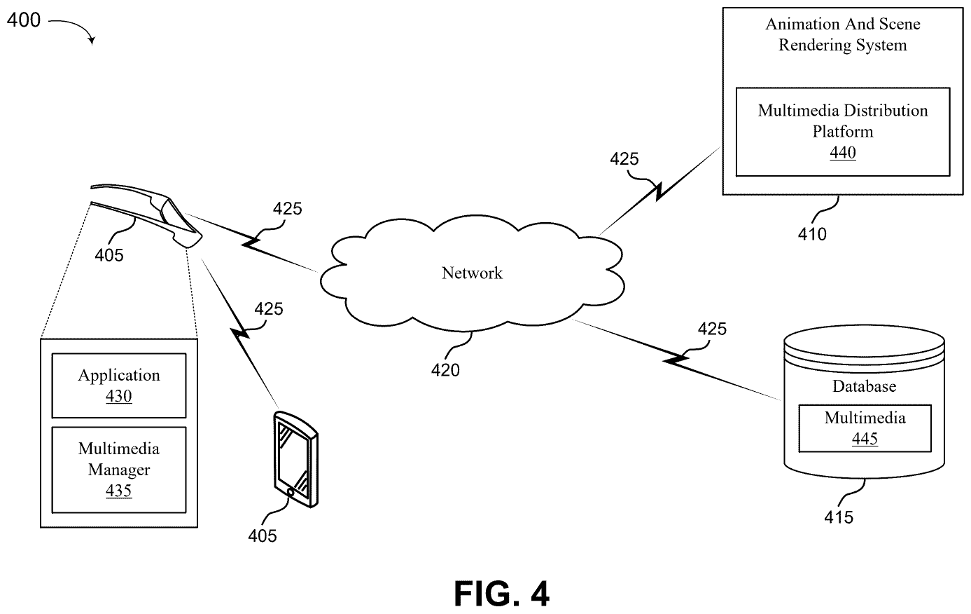

FIG. 4 is a diagram illustrating an example of a system 400 that can be used to perform the systems and techniques described herein, in accordance with aspects of the present disclosure. As shown, the system 400 includes client devices 405, an animation and scene rendering system 410, and storage 415. Although the system 400 illustrates two devices 405, a single animation and scene rendering system 410, a single storage 415, and a single network 420, the present disclosure applies to any system architecture having one or more devices 405, animation and scene rendering systems 410, storage 415, and networks 420. In some cases, the storage 415 may be part of the animation and scene rendering system 410. The devices 405, the animation and scene rendering system 410, and the storage 415 may communicate with each other and exchange information that supports generation of virtual content for XR, such as multimedia packets, multimedia data, multimedia control information, pose prediction parameters, via network 420 using communications links 425. In some cases, a portion of the techniques described herein for providing distributed generation of virtual content may be performed by one or more of the devices 405 and a portion of the techniques may be performed by the animation and scene rendering system 410, or both.

A device 405 may be an XR device (e.g., a head-mounted display (HMD), XR glasses such as virtual reality (VR) glasses, augmented reality (AR) glasses, etc.), a mobile device (e.g., a cellular phone, a smartphone, a personal digital assistant (PDA), etc.), a wireless communication device, a tablet computer, a laptop computer, and/or other device that supports various types of communication and functional features related to multimedia (e.g., transmitting, receiving, broadcasting, streaming, sinking, capturing, storing, and recording multimedia data). A device 405 may, additionally or alternatively, be referred to by those skilled in the art as a user equipment (UE), a user device, a smartphone, a Bluetooth device, a Wi-Fi device, a mobile station, a subscriber station, a mobile unit, a subscriber unit, a wireless unit, a remote unit, a mobile device, a wireless device, a wireless communications device, a remote device, an access terminal, a mobile terminal, a wireless terminal, a remote terminal, a handset, a user agent, a mobile client, a client, and/or some other suitable terminology. In some cases, the devices 405 may also be able to communicate directly with another device (e.g., using a peer-to-peer (P2P) or device-to-device (D2D) protocol, such as using sidelink communications). For example, a device 405 may be able to receive from or transmit to another device 405 variety of information, such as instructions or commands (e.g., multimedia-related information).

The devices 405 may include an application 430 and a multimedia manager 435. While the system 400 illustrates the devices 405 including both the application 430 and the multimedia manager 435, the application 430 and the multimedia manager 435 may be an optional feature for the devices 405. In some cases, the application 430 may be a multimedia-based application that can receive (e.g., download, stream, broadcast) from the animation and scene rendering systems 410, storage 415 or another device 405, or transmit (e.g., upload) multimedia data to the animation and scene rendering systems 410, the storage 415, or to another device 405 via using communications links 425.

The multimedia manager 435 may be part of a general-purpose processor, a digital signal processor (DSP), an image signal processor (ISP), a central processing unit (CPU), a graphics processing unit (GPU), a microcontroller, an application-specific integrated circuit (ASIC), a field-programmable gate array (FPGA), a discrete gate or transistor logic component, a discrete hardware component, or any combination thereof, or other programmable logic device, discrete gate or transistor logic, discrete hardware components, or any combination thereof designed to perform the functions described in the present disclosure, and/or the like. For example, the multimedia manager 435 may process multimedia (e.g., image data, video data, audio data) from and/or write multimedia data to a local memory of the device 405 or to the storage 415.

The multimedia manager 435 may also be configured to provide multimedia enhancements, multimedia restoration, multimedia analysis, multimedia compression, multimedia streaming, and multimedia synthesis, among other functionality. For example, the multimedia manager 435 may perform white balancing, cropping, scaling (e.g., multimedia compression), adjusting a resolution, multimedia stitching, color processing, multimedia filtering, spatial multimedia filtering, artifact removal, frame rate adjustments, multimedia encoding, multimedia decoding, and multimedia filtering. By further example, the multimedia manager 435 may process multimedia data to support server-based pose prediction for XR, according to the techniques described herein.

The animation and scene rendering system 410 may be a server device, such as a data server, a cloud server, a server associated with a multimedia subscription provider, proxy server, web server, application server, communications server, home server, mobile server, edge or cloud-based server, a personal computer acting as a server device, a mobile device such as a mobile phone acting as a server device, an XR device acting as a server device, a network router, any combination thereof, or other server device. The animation and scene rendering system 410 may in some cases include a multimedia distribution platform 440. In some cases, the multimedia distribution platform 440 may be a separate device or system from the animation and scene rendering system 410. The multimedia distribution platform 440 may allow the devices 405 to discover, browse, share, and download multimedia via network 420 using communications links 425, and therefore provide a digital distribution of the multimedia from the multimedia distribution platform 440. As such, a digital distribution may be a form of delivering media content such as audio, video, images, without the use of physical media but over online delivery mediums, such as the Internet. For example, the devices 405 may upload or download multimedia-related applications for streaming, downloading, uploading, processing, enhancing, etc. multimedia (e.g., images, audio, video). The animation and scene rendering system 410 or the multimedia distribution platform 440 may also transmit to the devices 405 a variety of information, such as instructions or commands (e.g., multimedia-related information) to download multimedia-related applications on the device 405.

The storage 415 may store a variety of information, such as instructions or commands (e.g., multimedia-related information). For example, the storage 415 may store multimedia 445, information from devices 405 (e.g., pose information, representation information for virtual representations or avatars of users, such as codes or features related to facial representations, body representations, hand representations, etc., and/or other information). A device 405 and/or the animation and scene rendering system 410 may retrieve the stored data from the storage 415 and/or more send data to the storage 415 via the network 420 using communication links 425. In some examples, the storage 415 may be a memory device (e.g., read only memory (ROM), random access memory (RAM), cache memory, buffer memory, etc.), a relational database (e.g., a relational database management system (RDBMS) or a Structured Query Language (SQL) database), a non-relational database, a network database, an object-oriented database, or other type of database, that stores the variety of information, such as instructions or commands (e.g., multimedia-related information).

The network 420 may provide encryption, access authorization, tracking, Internet Protocol (IP) connectivity, and other access, computation, modification, and/or functions. Examples of network 420 may include any combination of cloud networks, local area networks (LAN), wide area networks (WAN), virtual private networks (VPN), wireless networks (using 802.11, for example), cellular networks (using third generation (3G), fourth generation (4G), long-term evolved (LTE), or new radio (NR) systems (e.g., fifth generation (5G)), etc. Network 420 may include the Internet.

The communications links 425 shown in the system 400 may include uplink transmissions from the device 405 to the animation and scene rendering systems 410 and the storage 415, and/or downlink transmissions, from the animation and scene rendering systems 410 and the storage 415 to the device 405. The communications links 425 may transmit bidirectional communications and/or unidirectional communications. In some examples, the communication links 425 may be a wired connection or a wireless connection, or both. For example, the communications links 425 may include one or more connections, including but not limited to, Wi-Fi, Bluetooth, Bluetooth low-energy (BLE), cellular, Z-WAVE, 802.11, peer-to-peer, LAN, wireless local area network (WLAN), Ethernet, FireWire, fiber optic, and/or other connection types related to wireless communication systems.

In some aspects, a user of the device 405 (referred to as a first user) may be participating in a virtual session with one or more other users (including a second user of an additional device). In such examples, the animation and scene rendering systems 410 may process information received from the device 405 (e.g., received directly from the device 405, received from storage 415, etc.) to generate and/or animate a virtual representation (or avatar) for the first user. The animation and scene rendering systems 410 may compose a virtual scene that includes the virtual representation of the user and in some cases background virtual information from a perspective of the second user of the additional device. The animation and scene rendering systems 410 may transmit (e.g., via network 120) a frame of the virtual scene to the additional device. Further details regarding such aspects are provided below.

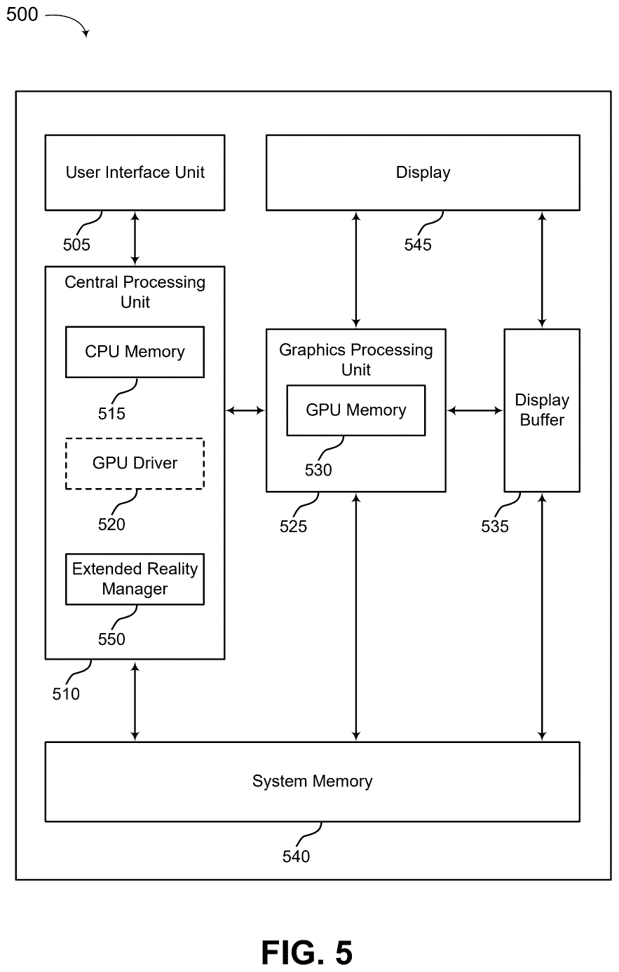

FIG. 5 is a diagram illustrating an example of a device 500. The device 500 can be implemented as a client device (e.g., device 405 of FIG. 4) or as an animation and scene rendering system (e.g., the animation and scene rendering system 410). As shown, the device 500 includes a central processing unit (CPU) 510 having CPU memory 515, a GPU 525 having GPU memory 530, a display 545, a display buffer 535 storing data associated with rendering, a user interface unit 505, and a system memory 540. For example, system memory 540 may store a GPU driver 520 (illustrated as being contained within CPU 510 as described below) having a compiler, a GPU program, a locally-compiled GPU program, and the like. User interface unit 505, CPU 510, GPU 525, system memory 540, display 545, and extended reality manager 550 may communicate with each other (e.g., using a system bus).

Examples of CPU 510 include, but are not limited to, a digital signal processor (DSP), general purpose microprocessor, application specific integrated circuit (ASIC), field programmable logic array (FPGA), or other equivalent integrated or discrete logic circuitry. Although CPU 510 and GPU 525 are illustrated as separate units in the example of FIG. 5, in some examples, CPU 510 and GPU 525 may be integrated into a single unit. CPU 510 may execute one or more software applications. Examples of the applications may include operating systems, word processors, web browsers, e-mail applications, spreadsheets, video games, audio and/or video capture, playback or editing applications, or other such applications that initiate the generation of image data to be presented via display 545. As illustrated, CPU 510 may include CPU memory 515. For example, CPU memory 515 may represent on-chip storage or memory used in executing machine or object code. CPU memory 515 may include one or more volatile or non-volatile memories or storage devices, such as flash memory, a magnetic data media, an optical storage media, etc. CPU 510 may be able to read values from or write values to CPU memory 515 more quickly than reading values from or writing values to system memory 540, which may be accessed, e.g., over a system bus.

GPU 525 may represent one or more dedicated processors for performing graphical operations. For example, GPU 525 may be a dedicated hardware unit having fixed function and programmable components for rendering graphics and executing GPU applications. GPU 525 may also include a DSP, a general-purpose microprocessor, an ASIC, an FPGA, or other equivalent integrated or discrete logic circuitry. GPU 525 may be built with a highly parallel structure that provides more efficient processing of complex graphic-related operations than CPU 510. For example, GPU 525 may include a plurality of processing elements that are configured to operate on multiple vertices or pixels in a parallel manner. The highly parallel nature of GPU 525 may allow GPU 525 to generate graphic images (e.g., graphical user interfaces and two-dimensional or three-dimensional graphics scenes) for display 545 more quickly than CPU 510.

GPU 525 may, in some instances, be integrated into a motherboard of device 500. In other instances, GPU 525 may be present on a graphics card or other device or component that is installed in a port in the motherboard of device 500 or may be otherwise incorporated within a peripheral device configured to interoperate with device 500. As illustrated, GPU 525 may include GPU memory 530. For example, GPU memory 530 may represent on-chip storage or memory used in executing machine or object code. GPU memory 530 may include one or more volatile or non-volatile memories or storage devices, such as flash memory, a magnetic data media, an optical storage media, etc. GPU 525 may be able to read values from or write values to GPU memory 530 more quickly than reading values from or writing values to system memory 540, which may be accessed, e.g., over a system bus. That is, GPU 525 may read data from and write data to GPU memory 530 without using the system bus to access off-chip memory. This operation may allow GPU 525 to operate in a more efficient manner by reducing the need for GPU 525 to read and write data via the system bus, which may experience heavy bus traffic.

Display 545 represents a unit capable of displaying video, images, text or any other type of data for consumption by a viewer. In some cases, such as when the device 500 is implemented as an animation and scene rendering system, the device 500 may not include the display 545. The display 545 may include a liquid-crystal display (LCD), a light emitting diode (LED) display, an organic LED (OLED), an active-matrix OLED (AMOLED), or the like. Display buffer 535 represents a memory or storage device dedicated to storing data for presentation of imagery, such as computer-generated graphics, still images, video frames, or the like for display 545. Display buffer 535 may represent a two-dimensional buffer that includes a plurality of storage locations. The number of storage locations within display buffer 535 may, in some cases, generally correspond to the number of pixels to be displayed on display 545. For example, if display 545 is configured to include 640×480 pixels, display buffer 535 may include 640×480 storage locations storing pixel color and intensity information, such as red, green, and blue pixel values, or other color values. Display buffer 535 may store the final pixel values for each of the pixels processed by GPU 525. Display 545 may retrieve the final pixel values from display buffer 535 and display the final image based on the pixel values stored in display buffer 535.

User interface unit 505 represents a unit with which a user may interact with or otherwise interface to communicate with other units of device 500, such as CPU 510. Examples of user interface unit 505 include, but are not limited to, a trackball, a mouse, a keyboard, and other types of input devices. User interface unit 505 may also be, or include, a touch screen and the touch screen may be incorporated as part of display 545.

System memory 540 may include one or more computer-readable storage media. Examples of system memory 540 include, but are not limited to, a random access memory (RAM), static RAM (SRAM), dynamic RAM (DRAM), a read-only memory (ROM), an electrically erasable programmable read-only memory (EEPROM), a compact disc read-only memory (CD-ROM) or other optical disc storage, magnetic disc storage, or other magnetic storage devices, flash memory, or any other medium that can be used to store desired program code in the form of instructions or data structures and that can be accessed by a computer or a processor. System memory 540 may store program modules and/or instructions that are accessible for execution by CPU 510. Additionally, system memory 540 may store user applications and application surface data associated with the applications. System memory 540 may in some cases store information for use by and/or information generated by other components of device 500. For example, system memory 540 may act as a device memory for GPU 525 and may store data to be operated on by GPU 555 as well as data resulting from operations performed by GPU 525

In some examples, system memory 540 may include instructions that cause CPU 510 or GPU 525 to perform the functions ascribed to CPU 510 or GPU 525 in aspects of the present disclosure. System memory 540 may, in some examples, be considered as a non-transitory storage medium. The term “non-transitory” should not be interpreted to mean that system memory 540 is non-movable. As one example, system memory 540 may be removed from device 500 and moved to another device. As another example, a system memory substantially similar to system memory 540 may be inserted into device 500. In certain examples, a non-transitory storage medium may store data that can, over time, change (e.g., in RAM).

System memory 540 may store a GPU driver 520 and compiler, a GPU program, and a locally compiled GPU program. The GPU driver 520 may represent a computer program or executable code that provides an interface to access GPU 525. CPU 510 may execute the GPU driver 520 or portions thereof to interface with GPU 525 and, for this reason, GPU driver 520 is shown in the example of FIG. 5 within CPU 510. GPU driver 520 may be accessible to programs or other executables executed by CPU 510, including the GPU program stored in system memory 540. Thus, when one of the software applications executing on CPU 510 requires graphics processing, CPU 510 may provide graphics commands and graphics data to GPU 525 for rendering to display 545 (e.g., via GPU driver 520).

In some cases, the GPU program may include code written in a high level (HL) programming language, e.g., using an application programming interface (API). Examples of APIs include Open Graphics Library (“OpenGL”), DirectX, Render-Man, WebGL, or any other public or proprietary standard graphics API. The instructions may also conform to so-called heterogeneous computing libraries, such as Open-Computing Language (“OpenCL”), DirectCompute, etc. In general, an API includes a predetermined, standardized set of commands that are executed by associated hardware. API commands allow a user to instruct hardware components of a GPU 525 to execute commands without user knowledge as to the specifics of the hardware components. In order to process the graphics rendering instructions, CPU 510 may issue one or more rendering commands to GPU 525 (e.g., through GPU driver 520) to cause GPU 525 to perform some or all of the rendering of the graphics data. In some examples, the graphics data to be rendered may include a list of graphics primitives (e.g., points, lines, triangles, quadrilaterals, etc.).

The GPU program stored in system memory 540 may invoke or otherwise include one or more functions provided by GPU driver 520. CPU 510 generally executes the program in which the GPU program is embedded and, upon encountering the GPU program, passes the GPU program to GPU driver 520. CPU 510 executes GPU driver 520 in this context to process the GPU program. That is, for example, GPU driver 520 may process the GPU program by compiling the GPU program into object or machine code executable by GPU 525. This object code may be referred to as a locally compiled GPU program. In some examples, a compiler associated with GPU driver 520 may operate in real-time or near-real-time to compile the GPU program during the execution of the program in which the GPU program is embedded. For example, the compiler generally represents a unit that reduces HL instructions defined in accordance with a HL programming language to low-level (LL) instructions of a LL programming language. After compilation, these LL instructions are capable of being executed by specific types of processors or other types of hardware, such as FPGAs, ASICs, and the like (including, but not limited to, CPU 510 and GPU 525).

In the example of FIG. 5, the compiler may receive the GPU program from CPU 510 when executing HL code that includes the GPU program. That is, a software application being executed by CPU 510 may invoke GPU driver 520 (e.g., via a graphics API) to issue one or more commands to GPU 525 for rendering one or more graphics primitives into displayable graphics images. The compiler may compile the GPU program to generate the locally compiled GPU program that conforms to a LL programming language. The compiler may then output the locally compiled GPU program that includes the LL instructions. In some examples, the LL instructions may be provided to GPU 525 in the form a list of drawing primitives (e.g., triangles, rectangles, etc.).

The LL instructions (e.g., which may alternatively be referred to as primitive definitions) may include vertex specifications that specify one or more vertices associated with the primitives to be rendered. The vertex specifications may include positional coordinates for each vertex and, in some instances, other attributes associated with the vertex, such as color coordinates, normal vectors, and texture coordinates. The primitive definitions may include primitive type information, scaling information, rotation information, and the like. Based on the instructions issued by the software application (e.g., the program in which the GPU program is embedded), GPU driver 520 may formulate one or more commands that specify one or more operations for GPU 525 to perform in order to render the primitive. When GPU 525 receives a command from CPU 510, it may decode the command and configure one or more processing elements to perform the specified operation and may output the rendered data to display buffer 535.

GPU 525 may receive the locally compiled GPU program, and then, in some instances, GPU 525 renders one or more images and outputs the rendered images to display buffer 535. For example, GPU 525 may generate a number of primitives to be displayed at display 545. Primitives may include one or more of a line (including curves, splines, etc.), a point, a circle, an ellipse, a polygon (e.g., a triangle), or any other two-dimensional primitive. The term “primitive” may also refer to three-dimensional primitives, such as cubes, cylinders, sphere, cone, pyramid, torus, or the like. Generally, the term “primitive” refers to any basic geometric shape or element capable of being rendered by GPU 525 for display as an image (or frame in the context of video data) via display 545. GPU 525 may transform primitives and other attributes (e.g., that define a color, texture, lighting, camera configuration, or other aspect) of the primitives into a so-called “world space” by applying one or more model transforms (which may also be specified in the state data). Once transformed, GPU 525 may apply a view transform for the active camera (which again may also be specified in the state data defining the camera) to transform the coordinates of the primitives and lights into the camera or eye space. GPU 525 may also perform vertex shading to render the appearance of the primitives in view of any active lights. GPU 525 may perform vertex shading in one or more of the above model, world, or view space.

Once the primitives are shaded, GPU 525 may perform projections to project the image into a canonical view volume. After transforming the model from the eye space to the canonical view volume, GPU 525 may perform clipping to remove any primitives that do not at least partially reside within the canonical view volume. For example, GPU 525 may remove any primitives that are not within the frame of the camera. GPU 525 may then map the coordinates of the primitives from the view volume to the screen space, effectively reducing the three-dimensional coordinates of the primitives to the two-dimensional coordinates of the screen. Given the transformed and projected vertices defining the primitives with their associated shading data, GPU 525 may then rasterize the primitives. Generally, rasterization may refer to the task of taking an image described in a vector graphics format and converting it to a raster image (e.g., a pixelated image) for output on a video display or for storage in a bitmap file format.

A GPU 525 may include a dedicated fast bin buffer (e.g., a fast memory buffer, such as GMEM, which may be referred to by GPU memory 530). As discussed herein, a rendering surface may be divided into bins. In some cases, the bin size is determined by format (e.g., pixel color and depth information) and render target resolution divided by the total amount of GMEM. The number of bins may vary based on device 500 hardware, target resolution size, and target display format. A rendering pass may draw (e.g., render, write, etc.) pixels into GMEM (e.g., with a high bandwidth that matches the capabilities of the GPU). The GPU 525 may then resolve the GMEM (e.g., burst write blended pixel values from the GMEM, as a single layer, to a display buffer 535 or a frame buffer in system memory 540). Such may be referred to as bin-based or tile-based rendering. When all bins are complete, the driver may swap buffers and start the binning process again for a next frame.

For example, GPU 525 may implement a tile-based architecture that renders an image or rendering target by breaking the image into multiple portions, referred to as tiles or bins. The bins may be sized based on the size of GPU memory 530 (e.g., which may alternatively be referred to herein as GMEM or a cache), the resolution of display 545, the color or Z precision of the render target, etc. When implementing tile-based rendering, GPU 525 may perform a binning pass and one or more rendering passes. For example, with respect to the binning pass, GPU 525 may process an entire image and sort rasterized primitives into bins.

The device 500 may use sensor data, sensor statistics, or other data from one or more sensors. Some examples of the monitored sensors may include IMUs, eye trackers, tremor sensors, heart rate sensors, etc. In some cases, an IMU may be included in the device 500, and may measure and report a body's specific force, angular rate, and sometimes the orientation of the body, using some combination of accelerometers, gyroscopes, or magnetometers.

As shown, device 500 may include an extended reality manager 550. The extended reality manager 550 may implement aspects of extended reality, augmented reality, virtual reality, etc. In some cases, such as when the device 500 is implemented as a client device (e.g., device 405 of FIG. 4), the extended reality manager 550 may determine information associated with a user of the device and/or a physical environment in which the device 500 is located, such as facial information, body information, hand information, device pose information, audio information, etc. The device 500 may transmit the information to an animation and scene rendering system (e.g., animation and scene rendering system 410). In some cases, such as when the device 500 is implemented as an animation and scene rendering system (e.g., the animation and scene rendering system 410 of FIG. 4), the extended reality manager 550 may process the information provided by a client device as input information to generate and/or animate a virtual representation for a user of the client device.

Virtual representations (e.g., avatars) are an important component of virtual environments. A virtual representation (or avatar) is a 3D representation of a user and allows the user to interact with the virtual scene. There are different ways to represent a virtual representation of a user (e.g., an avatar) and corresponding animation data. For example, avatars may be purely synthetic or may be an accurate representation of the user (e.g., as shown by the virtual representation 302 shown in the image of FIG. 3).

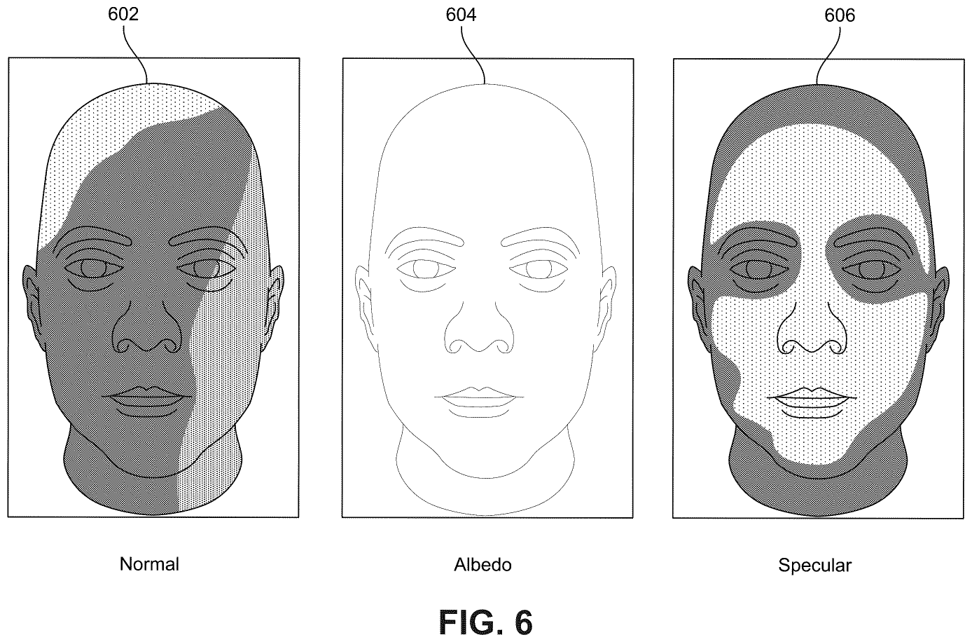

Various animation assets may be needed to model an avatar, including a mesh (e.g., a 3D mesh, such as a triangle mesh, including a plurality of vertices and line segments connected the vertices), a diffuse or albedo texture, normals specular reflection texture, and in some cases other types of textures. These various assets may be available from enrollment or offline reconstruction. FIG. 6 is a diagram illustrating an example of a normal map 602, an albedo map 604, and a specular reflection map 606.

As previously mentioned, a virtual representation of a user or a character (e.g., a game-based character, a movie-based character, or a book-based character) can be used as a representation of the user or the character in various different environments or applications (e.g., a virtual environment, a gaming environment, or a social media application). A virtual representation of a user or a character can be referred to herein as an avatar, a skin, or a game character.

Avatars and skins are very popular and extremely valuable in virtual reality (e.g., such as VR, XR, and MR), gaming, and professional sports. Currently, typically, there are not any mechanisms that allow for user-defined personalization of the avatars and skins. Although there are some instances that allow for some personalization of avatars and skins, these systems are mainly controlled by gaming platforms, not by the user's own preferences and/or the community popularity. Therefore, improved systems and techniques for generation of skins and avatars using user priority and community popularity can be useful.

In one or more aspects, the systems and techniques provide solutions for the generation of skins and avatars using user priority and popularity weights. In one or more examples, systems and techniques provide solutions for generation of highly personalized skins and avatars that are based on user definitions. In some examples, these solutions employ a generative artificial intelligence (GenAI) framework, which includes a generator and a discriminator. The generator can produce images (e.g., fake images) from random noise, and the discriminator can compare the generated images (e.g., fake images) with real images. The discriminator and the generator can be trained separately. In one or more examples, the systems and techniques can utilize, for personalizing the skins and avatars, user (owner) defined prioritization and/or preferences, community popularity, and/or user (owner) historical usage-based discriminator and generator loss modifications,

In one or more aspects, GenAI is a subset of artificial intelligence that utilizes generative models to produce text, images, video, or other forms of data. These models can learn the underlying patterns and structures of their training data and use the patterns and structures to produce new data based on an input (e.g., which can be in the form of natural language prompts).

A GenAI system can be constructed by applying unsupervised machine learning, such as by invoking neural network architectures, including generative adversarial networks (GANs), variation autoencoders (VAEs), transformers, or self-supervised machine learning trained on a dataset. The capabilities of a GenAI system depend upon the modality or type of dataset that is utilized. A GenAI system can be either a unimodal system (e.g., a system that can receive only one type of input) or a multimodal system (e.g., a system that can receive more than one type of input).

As mentioned, a GenAI system can employ a neural network architecture in the form of a generative adversarial network (GAN). A GAN is a class of machine learning frameworks for generative artificial intelligence. In a GAN framework, there are two neural networks (e.g., a discriminator and a generator) that compete with each other (e.g., in an adversarial manner) in the form of a zero-sum game, where one agent's gain is the other agent's loss.

Given a training dataset, a GAN can learn to generate new data with the same statistics as the training dataset. For example, a GAN trained on photographs (e.g., real, authentic photographs) can generate new photographs (e.g., fake photographs) that appear at least superficially authentic to human observers, where the new photographs have many realistic characteristics. The potential of GANs is huge because GANs can learn to mimic any distribution of data.

The core operation of a GAN is based on indirect training through the discriminator, which determines how realistic the input (e.g., a generated image) appears, which itself is also being updated dynamically. The generator is trained to deceive the discriminator into identifying a generated candidate (e.g., a fake image) as authentic. A GAN can be trained to learn in an unsupervised manner.

During operation of a GAN, the generator can generate candidates (e.g., fake images), and the discriminator can evaluate the candidates for authenticity. The contest between the generator and the discriminator can operate in terms of data distributions. The generator can learn to map from a latent space to a data distribution of interest. The discriminator can distinguish the candidates produced by the generator from the true data distribution. The training objective of the generator is to increase the error rate of the discriminator (e.g., to deceive the discriminator into identifying candidates as being authentic or part of the true data distribution).

The discriminator and the generator of a GAN need to be trained. The discriminator will be trained prior to the training of the generator. A known dataset (e.g., including real, authentic photographs) can serve as an initial training dataset for the discriminator. The discriminator can be trained by providing samples of the training dataset to the discriminator until the discriminator can achieve an acceptable accuracy for determining authentic candidates.

After the discriminator is trained, the generator can be trained. The generator is trained based on whether the generator can successfully deceive the discriminator (e.g., deceive the discriminator into identifying the generated candidates as being authentic). The generator can be seeded with a randomized input (e.g., a random number) that is sampled from a latent space (e.g., a multivariate normal distribution). The candidates synthesized by the generator can then be evaluated by the discriminator.

An independent backpropagation procedure can be applied to both the discriminator and the generator such that the generator can generate more candidates that appear more authentic, and the discriminator can become more skillful at identifying the synthetic candidates. In one or more examples, when a GAN is used for image generation, the generator may be in the form of a deconvolutional neural network, and the discriminator may be in the form of a convolutional neural network.

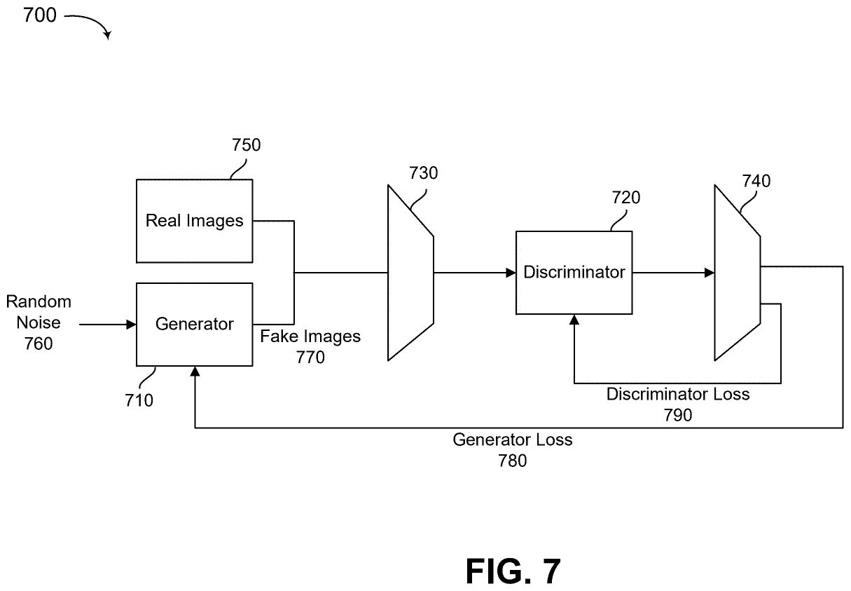

FIG. 7 shows an example of a system employing a GenAI framework in the form of a GAN. In particular, FIG. 7 is a diagram illustrating an example of a system 700 for generation of images. In FIG. 7, the system 700 is shown to include a generator 710, a discriminator 720, a combiner 730, and a reverse combiner 740. The generator 710 and the discriminator 720 each include a neural network.

For the system 700, the generator 710 and the discriminator 720 need to be trained. The discriminator 720 can be trained prior to the training of the generator 710.

For the training of the discriminator 720, the parameters (e.g., including neural network weights) for the generator 710 can be held constant. The generator 710 can generate fake images 770 based on a randomized input (e.g., which may be random noise 760). A dataset (e.g., a ground truth dataset) of real images 750 along with the fake images 770 can be inputted into the combiner 730. The output (e.g., which includes the fake images 770 and the real images 750) of the combiner 730 can be inputted into the discriminator 720.

The discriminator 720 can compare each of the fake images 770 with the real images 750 of the dataset (e.g., a ground truth dataset) to determine whether each of the fake images 770 is an authentic image or not. As such, based on the comparison, the discriminator 720 can determine whether each of the fake images 770 belongs to the dataset (e.g., the ground truth dataset) of the real images 750 or not. In one or more examples, for each fake image 770 evaluated by the discriminator 720, the discriminator 720 can return a probability (e.g., a number between zero and one, where one represents a prediction of authenticity and zero represents a prediction of not being authentic) regarding the authenticity of the fake image 770. The goal of the discriminator 720 is to accurately identify the fake images 770 as being not authentic.

The discriminator 720 can output a discriminator loss 790. The discriminator loss 790 can be based on the accuracy of the discriminator 720 for determining whether a fake image 770 is not authentic. The discriminator loss 790 can be inputted into the reverse combiner 740. The output (e.g., including the discriminator loss 790) of the reverse combiner 740 can be input into the discriminator 720. The parameters (e.g., including neural network weights) of the discriminator 720 can be tuned, based on the discriminator loss 790, until the discriminator 720 achieves an acceptable accuracy for determining the fake images 770 as not being authentic.

After the discriminator has been 720 trained, the generator 710 can be trained. For the training of the generator 710, the parameters (e.g., including neural network weights) for the discriminator 720 can be held constant. The generator 710 can generate fake images 770 based on a randomized input (e.g., random noise 760). A dataset (e.g., a ground truth dataset) of real images 750 and the fake images 770 can be inputted into the combiner 730. The output (e.g., including the fake images 770 and the real images 750) of the combiner 730 can be inputted into the discriminator 720.

The discriminator 720 can compare each of the fake images 770 with the real images 750 of the dataset to determine whether each of the fake images 770 is an authentic image or not. The discriminator 720 can output a generator loss 780. The generator loss 780 can be based on the successfulness of the generator 710 for generating fake images 770 that can appear as being authentic. The generator loss 780 can be inputted into the reverse combiner 740. The output (e.g., including the generator loss 780) of the reverse combiner 740 can be input into the generator 710. The parameters (e.g., including neural network weights) of the generator 710 can be tuned, based on the generator loss 780. The goal of the generator 710 is to generate fake images 770 that appear realistic enough such that the discriminator 720 incorrectly identifies them as being authentic.

After the generator 710 and the discriminator 720 have been trained, the system 700 is operational. During operation of the system 700, the generator 710 can generate fake images 770 based on a randomized input (e.g., random noise 760). Since the generator 710 has been trained, the fake images 770 should have realistic features such that they appear authentic. A dataset (e.g., a ground truth dataset) of real images 750 and the fake images 770 can be inputted into the combiner 730. The output (e.g., including the fake images 770 and the real images 750) of the combiner 730 can be inputted into the discriminator 720. The discriminator 720 can compare each of the fake images 770 with the real images 750 of the dataset (e.g., a ground truth dataset) to determine whether each of the fake images 770 is an authentic image or not. Since the discriminator 720 has been trained, the discriminator 720 should be able to identify, with a high level of accuracy, that the fake images 770 are not authentic.

As previously mentioned, the systems and techniques can employ GenAI (e.g., in the form of a GAN) to generate personalized avatars and skins. In one or more examples, for generation of the avatars and skins, a dataset (e.g., a ground truth dataset) of skins and avatars can be modified based on user preferences (e.g., owner priority) and community popularity (e.g., popularity weights). The user preferences can be based on user's albums (e.g., images on one or more devices associated with the user, such as may be from social media) and/or user sentiments (e.g., natural language text or emoji posts by the user, such as from social media posts). The community popularity can be based on available avatars and skins (e.g., on a game platform) that are popular within the public. In some examples, the community popularity can be based on the number of instances that the avatar is used on a one or more websites being greater than a threshold number of times. In one or more examples, user (owner) historical usage (e.g., recent historical usage of avatars by the user) can be used to modify the discriminator loss and generator loss during the trainings to capture the user preferences.

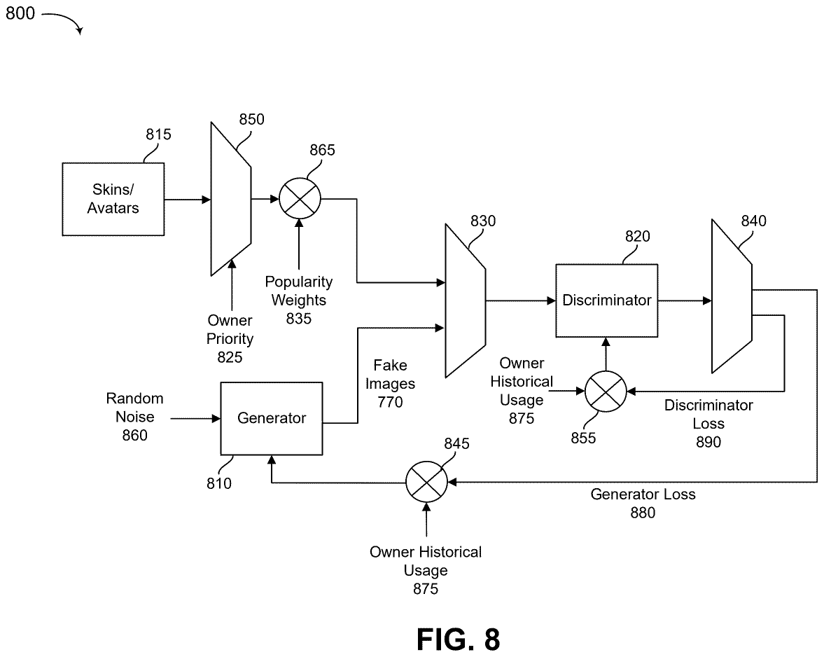

FIG. 8 shows an example system for generating skins and avatars using a dataset modified by user preferences and community popularity as well as discriminator and generator losses modified by user historical usage. In particular, FIG. 8 is a diagram illustrating an example of a system 800 for generation of skins and avatars using user (owner) historical usage. In FIG. 8, the system 800 is shown to include a generator 810, a discriminator 820, a combiner 830, a reverse combiner 840, an encoder 850, a multiplier 865, and summers 845, 875. The generator 810 and the discriminator 820 each include a neural network.

For the system 800, the generator 810 and the discriminator 820 can be trained. The discriminator 820 can be trained prior to the training of the generator 810. For the training of the discriminator 820, the parameters (e.g., including neural network weights) for the generator 810 can be held constant (e.g., frozen). The generator 810 can generate fake images 870 based on a randomized input (e.g., which may be random noise 860).

A dataset of skins and avatars 815 (e.g., referred to as candidate avatars and skins) and an owner priority 825 (e.g., user preferences) are shown to be inputted into the encoder 850. The encoder 850 can, based on the owner priority 825 (e.g., user preferences), extract features from the dataset of skins and avatars 815. The extracted features can be multiplied, by the multiplier 865, with popularity weights 835 (e.g., based on available avatars and skins that are popular within the public) to produce a modified dataset of avatars (and skins), also referred to herein as a modified dataset.

The modified dataset of avatars (and skins) along with the fake images 870 can be inputted into the combiner 830. The output (e.g., which includes the fake images 770 and the modified dataset) of the combiner 830 can be inputted into the discriminator 820.

The discriminator 820 can compare each of the fake images 870 with the skins and avatars of the modified dataset (e.g., a ground truth dataset) to determine whether each of the fake images 870 is an authentic image or not (e.g., belongs in the ground truth dataset). In one or more examples, for each fake image 870 evaluated by the discriminator 820, the discriminator 820 can return a probability (e.g., a number between zero and one, where one represents a prediction of authenticity and zero represents a prediction of not being authentic) regarding the authenticity of the fake image 870. The goal of the discriminator 820 is to accurately identify the fake images 870 as being not authentic (e.g., not belonging to the ground truth dataset).

The discriminator 820 can output a discriminator loss 890. The discriminator loss 890 can be based on the accuracy of the discriminator 820 for determining whether a fake image 870 is not authentic. The discriminator loss 890 can be inputted into the reverse combiner 840. The output (e.g., including the discriminator loss 890) of the reverse combiner 840 can be summed, by a summer 855, with the owner (user) historical usage 875 to generate a modified discriminator loss. The modified discriminator loss can be input into the discriminator 820. The parameters (e.g., including neural network weights) of the discriminator 820 can be tuned, based on the modified discriminator loss, until the discriminator 820 achieves an acceptable accuracy for determining the fake images 870 as not being authentic (e.g., not belonging to the ground truth dataset).

After the discriminator has been 820 trained, the generator 810 can be trained. For the training of the generator 810, the parameters (e.g., including neural network weights) for the discriminator 820 can be held constant. The generator 810 can generate fake images 870 based on a randomized input (e.g., random noise 860).

The dataset (e.g., a ground truth dataset) of skins and avatars 815 and the owner priority 825 are shown to be inputted into the encoder 850. The encoder 850 can, based on the owner priority 825, extract features from the dataset of skins and avatars 815. The extracted features can be multiplied, by the multiplier 865, with popularity weights 835 to produce a modified dataset.

A modified dataset and the fake images 870 can be inputted into the combiner 830. The output (e.g., including the fake images 870 and the modified dataset) of the combiner 830 can be inputted into the discriminator 820.

The discriminator 820 can compare each of the fake images 870 with the skins and avatars of the modified dataset to determine whether each of the fake images 870 is an authentic image or not. The discriminator 820 can output a generator loss 880. The generator loss 880 can be based on the successfulness of the generator 810 for generating fake images 870 that can appear as being authentic (e.g., belonging to the ground truth dataset). The generator loss 880 can be inputted into the reverse combiner 840. The output (e.g., including the generator loss 880) of the reverse combiner 840 can be summed, by a summer 845, with the owner (user) historical usage 875 to generate a modified generator loss. The modified generator loss can be input into the generator 810. The parameters (e.g., including neural network weights) of the generator 810 can be tuned, based on the modified generator loss 880. The goal of the generator 810 is to generate fake images 870 such that the discriminator 820 incorrectly identifies them as being authentic.

After the generator 810 and the discriminator 820 have been trained, the system 800 is operational. During operation of the system 800, the generator 810 can generate fake images 870 based on a randomized input (e.g., random noise 860). Since the generator 810 has been trained, the fake images 870 should have features such that they appear authentic (e.g., belong to the ground truth dataset).

The dataset of skins and avatars 815 and the owner priority 825 are shown to be inputted into the encoder 850. The encoder 850 can, based on the owner priority 825, extract features from the dataset of skins and avatars 815. The extracted features can be multiplied, by the multiplier 865, with popularity weights 835 to produce a modified dataset. The modified dataset along with the fake images 870 can be inputted into the combiner 830. The output (e.g., which includes the fake images 870 and the modified dataset) of the combiner 830 can be inputted into the discriminator 820.

The discriminator 820 can compare each of the fake images 870 with the skins and avatars of the modified dataset (e.g., a ground truth dataset) to determine whether each of the fake images 870 is an authentic image or not. Since the discriminator 820 has been trained, the discriminator 820 should be able to identify, with a high level of accuracy, that the fake images 870 are not authentic.

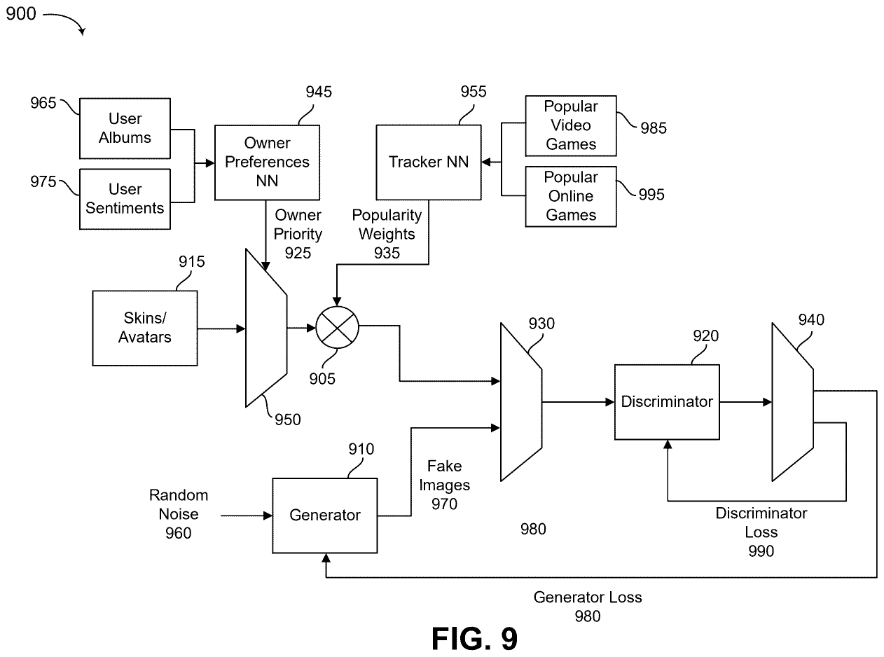

FIG. 9 shows an example system for generating skins and avatars using a dataset modified by user preferences (e.g., user priority) and community popularity. In particular, FIG. 9 is a diagram illustrating an example of a system 900 for generation of skins and avatars using user priority and community popularity. In FIG. 9, the system 900 is shown to include a generator 910, a discriminator 920, a combiner 930, a reverse combiner 940, an encoder 950, a multiplier 905, an owner preference neural network (NN) 945, and a tracker neural network 955. The generator 910, the discriminator 920, and owner preferences NN 945, and the tracker NN 955 each include a neural network.

For the system 900, the generator 910 and the discriminator 920 need to be trained. The discriminator 920 can be trained prior to the training of the generator 910.

For the training of the discriminator 920, the parameters (e.g., including neural network weights) for the generator 910 can be held constant. The generator 910 can generate fake images 970 based on a randomized input (e.g., which may be random noise 960).

A dataset of user's albums 965 (e.g., including user images) and a dataset of user sentiments 975 (e.g., including user natural language text and/or emojis) are shown to be input into the owner preferences NN 945. The owner preferences NN 945, based on the dataset of user's albums 965 and a dataset of user sentiments 975, can generate an owner priority 925 (e.g., user preferences). In one or more examples, the owner preferences NN 945 can give a higher owner priority 925 to images in the user's albums 965 and user sentiments that are recent (e.g., have recent time and date stamps).

A dataset of skins and avatars 915 and the owner priority 925 are shown to be inputted into the encoder 950. The encoder 950 can, based on the owner priority 925 (e.g., user preferences), extract features from the dataset of skins and avatars 915.

A dataset of popular video games 985 (e.g., including popular avatars) and a dataset of best online games 995 (e.g., including popular avatars) are shown to be inputted into the tracker NN 955. The tracker NN 955, based on the dataset of popular video games 985 and the dataset of best online games 995, can determine popularity weights 935 for the available avatars (e.g., in the available games).

The extracted features extracted by the encoder 950 can be multiplied, by the multiplier 905, with popularity weights 935 (e.g., which are based on available avatars and skins in games that are popular within the public) to produce a modified dataset.

The modified dataset along with the fake images 970 can be inputted into the combiner 930. The output (e.g., which includes the fake images 970 and the modified dataset) of the combiner 930 can be inputted into the discriminator 920.

The discriminator 920 can compare each of the fake images 970 with the skins and avatars of the modified dataset (e.g., a ground truth dataset) to determine whether each of the fake images 970 is an authentic image or not (e.g., belongs in the ground truth dataset). In one or more examples, for each fake image 970 evaluated by the discriminator 920, the discriminator 920 can return a probability (e.g., a number between zero and one, where one represents a prediction of authenticity and zero represents a prediction of not being authentic) regarding the authenticity of the fake image 970. The goal of the discriminator 920 is to accurately identify the fake images 970 as being not authentic (e.g., not belonging to the ground truth dataset).

The discriminator 920 can output a discriminator loss 990. The discriminator loss 990 can be based on the accuracy of the discriminator 920 for determining whether a fake image 970 is not authentic. The discriminator loss 990 can be inputted into the reverse combiner 940. The output (e.g., including the discriminator loss 990) of the reverse combiner 940 can be input into the discriminator 920. The parameters (e.g., including neural network weights) of the discriminator 920 can be tuned, based on the discriminator loss 990, until the discriminator 920 achieves an acceptable accuracy for determining the fake images 970 as not being authentic.

After the discriminator has been 920 trained, the generator 910 can be trained. For the training of the generator 910, the parameters (e.g., including neural network weights) for the discriminator 920 can be held constant. The generator 910 can generate fake images 970 based on a randomized input (e.g., random noise 960).

The dataset of user's albums and the dataset of user sentiments 975 are shown to be input into the owner preferences NN 945. The owner preferences NN 945, based on the dataset of user's albums 965 and a dataset of user sentiments 975, can generate an owner priority 925. The dataset of skins and avatars 915 and the owner priority 925 are shown to be inputted into the encoder 950. The encoder 950 can, based on the owner priority 925, extract features from the dataset of skins and avatars 915.

The dataset of popular video games 985 and the dataset of best online games 995 are shown to be inputted into the tracker NN 955. The tracker NN 955, based on the dataset of popular video games 985 and the dataset of best online games 995, can determine popularity weights 935 for the available avatars. The extracted features extracted by the encoder 950 can be multiplied, by the multiplier 905, with popularity weights 935 to produce a modified dataset.

The modified dataset and the fake images 970 can be inputted into the combiner 930. The output (e.g., including the fake images 970 and the modified dataset) of the combiner 930 can be inputted into the discriminator 920.

The discriminator 920 can compare each of the fake images 970 with the skins and avatars of the modified dataset to determine whether each of the fake images 970 is an authentic image or not. The discriminator 920 can output a generator loss 980. The generator loss 980 can be based on the successfulness of the generator 910 for generating fake images 970 that can appear as being authentic (e.g., belonging to the ground truth dataset). The generator loss 980 can be inputted into the reverse combiner 940. The output (e.g., including the generator loss 980) of the reverse combiner 940 can be input into the generator 910. The parameters (e.g., including neural network weights) of the generator 910 can be tuned, based on the modified generator loss 980. The goal of the generator 910 is to generate fake images 970 such that the discriminator 920 incorrectly identifies them as being authentic (e.g., belonging to the ground truth dataset).

After the generator 910 and the discriminator 920 have been trained, the system 900 is operational. During operation of the system 900, the generator 910 can generate fake images 970 based on a randomized input (e.g., random noise 960). Since the generator 910 has been trained, the fake images 970 should have features such that they appear authentic (e.g., they belong to the ground truth dataset).

The dataset of user's albums and the dataset of user sentiments 975 are shown to be input into the owner preferences NN 945. The owner preferences NN 945, based on the dataset of user's albums 965 and a dataset of user sentiments 975, can generate an owner priority 925. The dataset of skins and avatars 915 and the owner priority 925 are shown to be inputted into the encoder 950. The encoder 950 can, based on the owner priority 925, extract features from the dataset of skins and avatars 915.

The dataset of popular video games 985 and the dataset of best online games 995 are shown to be inputted into the tracker NN 955. The tracker NN 955, based on the dataset of popular video games 985 and the dataset of best online games 995, can determine popularity weights 935 for the available avatars. The extracted features extracted by the encoder 950 can be multiplied, by the multiplier 905, with popularity weights 935 to produce a modified dataset.

The modified dataset and the fake images 970 can be inputted into the combiner 930. The output (e.g., which includes the fake images 970 and the modified dataset) of the combiner 930 can be inputted into the discriminator 920.

The discriminator 920 can compare each of the fake images 970 with the skins and avatars of the modified dataset (e.g., a ground truth dataset) to determine whether each of the fake images 970 is an authentic image or not (e.g., belongs to the ground truth dataset). Since the discriminator 920 has been trained, the discriminator 920 should be able to identify, with a high level of accuracy, that the fake images 970 are not authentic.

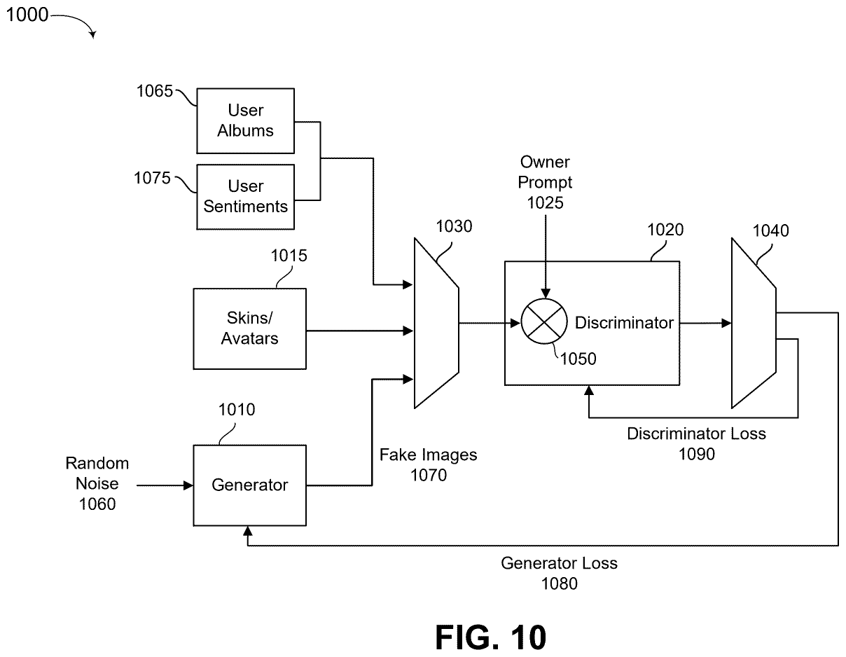

In one or more examples, for generation of the avatars and skins, user prompts that can indicate user preferences (e.g., owner priority) can be utilized. FIG. 10 shows an example system for generating skins and avatars using owner prompts. In particular, FIG. 10 is a diagram illustrating an example of a system 1000 for generation of skins and avatars using owner prompts (e.g., user priority). In FIG. 10, the system 1000 is shown to include a generator 1010, a discriminator 1020, a combiner 1030, a reverse combiner 1040, and a multiplier 1050. The generator 1010 and the discriminator 1020 each include a neural network.

For the system 1000, the generator 1010 and the discriminator 1020 need to be trained. The discriminator 1020 can be trained prior to the training of the generator 1010.

For the training of the discriminator 1020, the parameters (e.g., including neural network weights) for the generator 1010 can be held constant. The generator 1010 can generate fake images 1070 based on a randomized input (e.g., which may be random noise 1060).

A dataset of user's albums 1065 (e.g., including user images), a dataset of user sentiments 1075 (e.g., including user natural language text and/or emojis), a dataset of skins and avatars 1050, and the fake images 1070 are shown to be input into the combiner 1030. The dataset of user's albums 1065 and the dataset of user sentiments 1075 can be used indicate user preferences (e.g., owner priority). The output (e.g., which includes the dataset of user's albums 1065, the dataset of user sentiments 1075, the dataset of the skins and avatars 1015, and the fake images 1070) of the combiner 1030 can be inputted into the discriminator 1020.

The dataset of user's albums 1065, the dataset of user sentiments 1075, and the dataset of the skins and avatars 1015 can be multiplied, by the multiplier 1050, with owner prompts (op1, op2) 1025 to generate a modified dataset (e.g., modified according to user preferences). A probability (e.g., weighting) of features indicated by the owner prompts 1025 can be represented as:

$$Y = f ( \sum ( op 1 * weights 1 * in 1 + op 2 * weights 2 * in 2 + bias 1 + bias 2 ) ) ,$$

where op1 and op2 are the user prompts, the weights are the neural network weights, in1 and in2 are the inputs, and bias1 and bias2 are biases.

The discriminator 1020 can compare each of the fake images 1070 with the skins and avatars of the modified dataset (e.g., a ground truth dataset) to determine whether each of the fake images 1070 is an authentic image or not (e.g., belongs in the ground truth dataset). In one or more examples, for each fake image 1070 evaluated by the discriminator 1020, the discriminator 1020 can return a probability (e.g., a number between zero and one, where one represents a prediction of authenticity and zero represents a prediction of not being authentic) regarding the authenticity of the fake image 1070. The goal of the discriminator 1020 is to accurately identify the fake images 1070 as being not authentic (e.g., not belonging to the ground truth dataset).

The discriminator 1020 can output a discriminator loss 1090. The discriminator loss 1090 can be based on the accuracy of the discriminator 1020 for determining whether a fake image 1070 is not authentic. The discriminator loss 1090 can be inputted into the reverse combiner 1040. The output (e.g., including the discriminator loss 1090) of the reverse combiner 1040 can be input into the discriminator 1020. The parameters (e.g., including neural network weights) of the discriminator 1020 can be tuned, based on the discriminator loss 1090, until the discriminator 1020 achieves an acceptable accuracy for determining the fake images 1070 as not being authentic.

After the discriminator has been 1020 trained, the generator 1010 can be trained. For the training of the generator 1010, the parameters (e.g., including neural network weights) for the discriminator 1020 can be held constant. The generator 1010 can generate fake images 1070 based on a randomized input (e.g., random noise 1060).

The dataset of user's albums 1065 (e.g., including user images), the dataset of user sentiments 1075 (e.g., including user natural language text and/or emojis), the dataset of skins and avatars 1050, and the fake images 1070 are shown to be input into the combiner 1030. The output (e.g., which includes the dataset of user's albums 1065, the dataset of user sentiments 1075, the dataset of the skins and avatars 1015, and the fake images 1070) of the combiner 1030 can be inputted into the discriminator 1020.

The dataset of user's albums 1065, the dataset of user sentiments 1075, and the dataset of the skins and avatars 1015 can be multiplied, by the multiplier 1050, with owner prompts (op1, op2) 1025 to generate a modified dataset (e.g., modified according to user preferences).

The discriminator 1020 can compare each of the fake images 1070 with the skins and avatars of the modified dataset to determine whether each of the fake images 1070 is an authentic image or not. The discriminator 1020 can output a generator loss 1080. The generator loss 1080 can be based on the successfulness of the generator 1010 for generating fake images 1070 that can appear as being authentic (e.g., belonging to the ground truth dataset). The generator loss 1080 can be inputted into the reverse combiner 1040. The output (e.g., including the generator loss 1080) of the reverse combiner 1040 can be input into the generator 1010. The parameters (e.g., including neural network weights) of the generator 1010 can be tuned, based on the modified generator loss 1080. The goal of the generator 1010 is to generate fake images 1070 such that the discriminator 1020 incorrectly identifies them as being authentic (e.g., belonging to the ground truth dataset).

After the generator 1010 and the discriminator 1020 have been trained, the system 1000 is operational. During operation of the system 1000, the generator 1010 can generate fake images 1070 based on a randomized input (e.g., random noise 1060). Since the generator 1010 has been trained, the fake images 1070 should have features such that they appear authentic (e.g., they belong to the ground truth dataset).

The dataset of user's albums 1065 (e.g., including user images), the dataset of user sentiments 1075 (e.g., including user natural language text and/or emojis), the dataset of skins and avatars 1050, and the fake images 1070 are shown to be input into the combiner 1030. The output (e.g., which includes the dataset of user's albums 1065, the dataset of user sentiments 1075, the dataset of the skins and avatars 1015, and the fake images 1070) of the combiner 1030 can be inputted into the discriminator 1020.

The dataset of user's albums 1065, the dataset of user sentiments 1075, and the dataset of the skins and avatars 1015 can be multiplied, by the multiplier 1050, with owner prompts (op1, op2) 1025 to generate a modified dataset (e.g., modified according to user preferences).

The discriminator 1020 can compare each of the fake images 1070 with the skins and avatars of the modified dataset (e.g., a ground truth dataset) to determine whether each of the fake images 1070 is an authentic image or not (e.g., belongs to the ground truth dataset). Since the discriminator 1020 has been trained, the discriminator 1020 should be able to identify, with a high level of accuracy, that the fake images 1070 are not authentic.

In one or more aspects, user preferences (e.g., owner priority) can be indicated by an adaptive down selection of different skins for different environments (e.g., gaming environments). In one or more examples, the user preferences for the avatar may be prioritized. In some examples, the user preferences can include preferences for the avatar related to clothing type and/or color, hair type and/or color, and/or facial features. In one or more examples, the user preferences can include preferences for the avatar that are related to attitude and/or behavior. In some examples, the user preferences can be preferences related to a personalized skin based on the user's own physical appearance. In one or more examples, the user preferences can include selections for the avatar that are based on the game or location of the game. In one or more examples, the community popularity (e.g., popularity weights) can be added as user prompts based on the popularity of the skins and/or the player usage.

In some aspects, historical data-based discriminator and generator loss modifications can be employed. In one or more examples, a min-max GAN loss can be modified to include historical data from the user or friends of the user on the platform. The total min-max GAN loss can be represented as:

$${E}_{x} [ log ( D ( x ) ) ] + {E}_{z} [ log ( 1 - D ( G ( z ) ) ) ]$$

where Eₓ [log(D(x))] is the discriminator loss, and E_{z}[log(1−D(G(z)))] is the generator loss.

In one or more aspects, during operation of a method for generating an avatar, a generator (e.g., generator 810, 910, 1010 of FIGS. 8, 9, and 10, respectively) may generate, based on a noise input, a plurality of candidate avatars (or skins). One or more processors can modify, based on user preferences of a user for features of an avatar and/or popularity of available avatars, an initial dataset of avatars to generate a modified dataset of avatars. A discriminator (e.g., discriminator 820, 920, 1020 of FIGS. 8, 9, and 10, respectively) of a machine learning model may compare each candidate avatar of the plurality of candidate avatars with avatars in the modified dataset of avatars. The discriminator may determine, based on the comparing, whether each candidate avatar of the plurality of candidate avatars belongs in the modified dataset of avatars. In one or more examples, the discriminator may determine that a candidate avatar belongs in the modified dataset of avatars based on a difference between the candidate avatar and at least one avatar within the modified dataset of avatars being less than a threshold difference value.

In one or more examples, the discriminator may generate, based on the comparing, for each candidate avatar of the plurality of candidate avatars a respective probability associated with belonging in the modified dataset of avatars. In some examples, the noise input is based on random noise.

In one or more examples, the discriminator may be trained, based on the modified dataset of avatars, to determine whether each candidate avatar of the plurality of candidate avatars belongs in the modified dataset of avatars. During the training of the discriminator, the discriminator may generate a discriminator loss based on an accuracy of the discriminator to determine whether each candidate avatar of the plurality of candidate avatars belongs in the modified dataset of avatar. One or more processors may modify, based on historical usage of avatars by the user, the discriminator loss to generate a modified discriminator loss. The neural network weights of the discriminator may be tuned based on the modified discriminator loss.

In some examples, the generator may be trained, based on the modified dataset of avatars, to generate the plurality of candidate avatars to belong in the modified dataset of avatars. During the training of the generator, the generator may generate a generator loss based on an ability of the generator to generate the plurality of candidate avatars to belong in the modified dataset of avatars. One or more processors may modify, based on historical usage of avatars by the user, the generator loss to generate a modified generator loss. The neural network weights of the generator may be tuned based on the modified generator loss.

In one or more examples, the user preferences may be based on images associated with the user and/or social media posts associated with the user. In some examples, the user preferences for features of the avatar may include a type of clothing, a color of the clothing, a type of hair, a color of the hair, one or more facial features, an attitude, and/or a behavior. In one or more examples, the user preferences may be based on prompt-based weighting for user priority. In some examples, one or more processors may select, based on determining a candidate avatar of the plurality of candidate avatars belongs in the modified dataset of avatars, the candidate avatars for use by the user.

In one or more examples, the generator and the discriminator may be in a GAN. In some examples, the machine learning model may be a neural network.

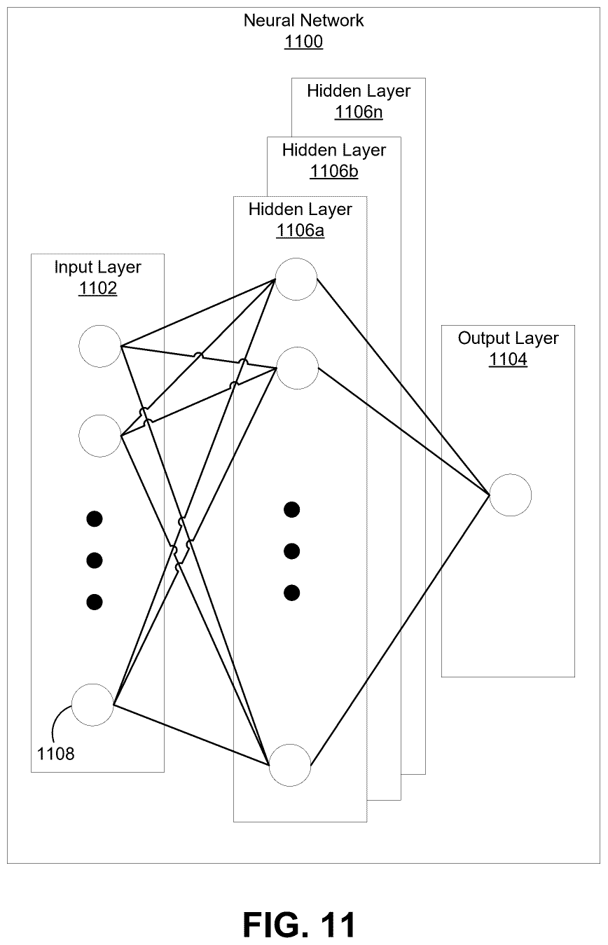

As described herein, the systems described herein can utilize one or more machine learning models (e.g., one or more neural networks). FIG. 11 is an illustrative example of a neural network 1100 (e.g., a deep-learning neural network) that can be implemented within one or more components of the disclosed systems.

Neural network 1100 includes multiple hidden layers hidden layers 1106a, 1106b, through 1106n. The hidden layers 1106a, 1106b, through hidden layer 1106n include “n” number of hidden layers, where “n” is an integer greater than or equal to one. The number of hidden layers can be made to include as many layers as needed for the given application. Neural network 1100 further includes an output layer 1104 that provides an output resulting from the processing performed by the hidden layers 1106a, 1106b, through 1106n.

Neural network 1100 may be, or may include, a multi-layer neural network of interconnected nodes. Each node can represent a piece of information. Information associated with the nodes is shared among the different layers and each layer retains information as information is processed. In some cases, neural network 1100 can include a feed-forward network, in which case there are no feedback connections where outputs of the network are fed back into itself. In some cases, neural network 1100 can include a recurrent neural network, which can have loops that allow information to be carried across nodes while reading in input.

Information can be exchanged between nodes through node-to-node interconnections between the various layers. Nodes of input layer 1102 can activate a set of nodes in the first hidden layer 1106a. For example, as shown, each of the input nodes of input layer 1102 is connected to each of the nodes of the first hidden layer 1106a. The nodes of first hidden layer 1106a can transform the information of each input node by applying activation functions to the input node information. The information derived from the transformation can then be passed to and can activate the nodes of the next hidden layer 1106b, which can perform their own designated functions. Example functions include convolutional, up-sampling, data transformation, and/or any other suitable functions. The output of the hidden layer 1106b can then activate nodes of the next hidden layer, and so on. The output of the last hidden layer 1106n can activate one or more nodes of the output layer 1104, at which an output is provided. In some cases, while nodes (e.g., node 1108) in neural network 1100 are shown as having multiple output lines, a node has a single output and all lines shown as being output from a node represent the same output value.

In some cases, each node or interconnection between nodes can have a weight that is a set of parameters derived from the training of neural network 1100. Once neural network 1100 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 1100 to be adaptive to inputs and able to learn as more and more data is processed.

Neural network 1100 may be pre-trained to process the features from the data in the input layer 1102 using the different hidden layers 1106a, 1106b, through 1106n in order to provide the output through the output layer 1104. In an example in which neural network 1100 is used to identify features in images, neural network 1100 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 1100 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training images until neural network 1100 is trained well enough so that the weights of the layers are accurately tuned.

For the example of identifying objects in images, the forward pass can include passing a training image through neural network 1100. The weights are initially randomized before neural network 1100 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 1100, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 1100 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as

$${E}_{total} = \sum \frac{1}{2} {( target - output )}^{2} .$$

The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 1100 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{d L}{dW} ,$$

where w denotes a weight, wᵢ denotes the initial weight, and n denotes a learning rate. The learning rate can be set to any suitable value, with a high learning rate including larger weight updates and a lower value indicating smaller weight updates.

Neural network 1100 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 1100 can include any other deep network other than a CNN, such as an autoencoder, a deep belief nets (DBNs), a Recurrent Neural Networks (RNNs), among others.

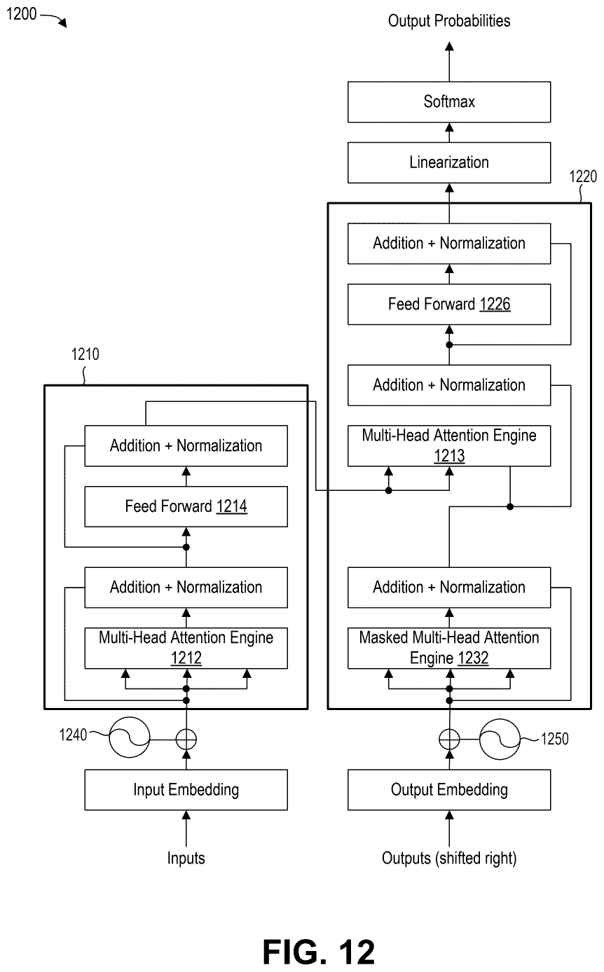

FIG. 12 is a block diagram of an example transformer in accordance with some aspects of the disclosure. In a convolutional neural network (CNN) model, the number of operations required to relate signals from two arbitrary input or output positions grows in the distance between positions, which makes learning dependencies at different distant positions challenging for a CNN model. A transformer 1200 reduces the operations of learning dependencies by using an encoder 1210 and a decoder 1220 that implement an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, the encoder 1210 is composed of a stack of six identical layers and each layer has two sub-layers. The first sub-layer is a multi-head self-attention engine 1212, and the second sub-layer is a fully connected feed-forward network 1214. A residual connection (not shown) connects around each of the sub-layers followed by normalization.

In this example transformer 1200, the decoder 1220 is also composed of a stack of six 6 identical layers. The decoder also includes a masked multi-head self-attention engine 1232, a multi-head attention engine 1213 over the output of the encoder 1210, and a fully connected feed-forward network 1226. Each layer includes a residual connection (not shown) around the layer, which is followed by layer normalization. The masked multi-head self-attention engine 1232 is masked to prevent positions from attending to subsequent positions and ensures that the predictions at position i can depend only on the known outputs at positions less than i (e.g., auto-regression).

In the transformer, the queries, keys, and values are linearly projected by a multi-head attention engine into learned linear projects, and then attention is performed in parallel on each of the learned linear projects, which are concatenated and then projected into final values.

The transformer also includes a positional encoder 1240 to encode positions because the model does not contain recurrence and convolution and relative or absolute position of the tokens is needed. In the transformer 1200, the positional encodings are added to the input embeddings at the bottom layer of the encoder 1210 and the decoder 1220. The positional encodings are summed with the embeddings because the positional encodings and embeddings have the same dimensions. A corresponding position decoder 1250 is configured to decode the positions of the embeddings for the decoder 1220.

In some aspects, the transformer 1200 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 1200 can process input sequences of variable length, making it well-suited for natural language processing tasks where input lengths can vary greatly. Additionally, the self-attention mechanism allows the transformer 1200 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

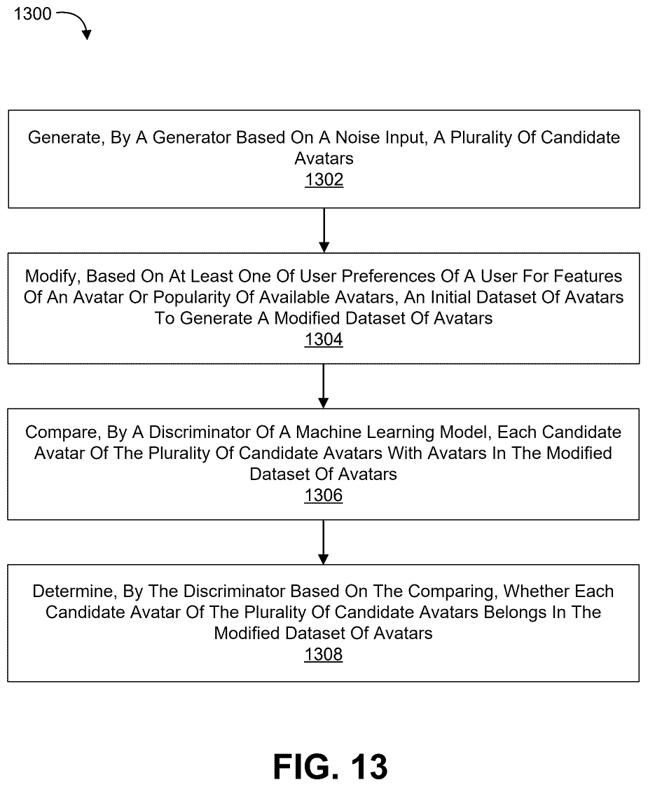

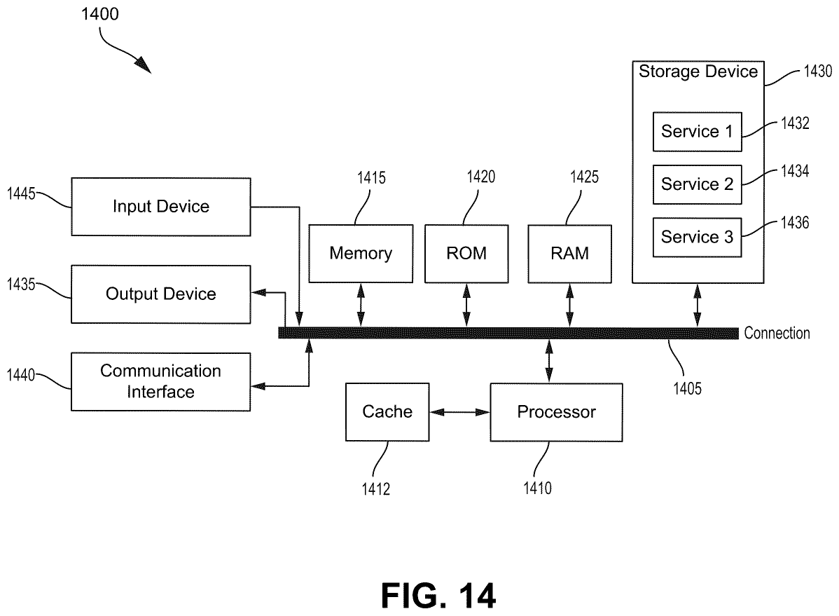

FIG. 13 is a flow chart illustrating an example of a process 1300 for avatar generation. The process 1300 can be performed by a computing device (e.g., a computing device or computing system 1400 of FIG. 14) or by a component or system (e.g., a chipset, one or more processors central processing units (CPUs), digital signal processors (DSPs), graphics processing units (GPUs), any combination thereof, and/or other type of processor(s), or other component or system) of the computing device. The operations of the process 1300 may be implemented as software components that are executed and run on one or more processors (e.g., processor 1410 of FIG. 14, or other processor(s)). Further, the transmission and reception of signals by the computing device in the process 1300 may be enabled, for example, by one or more antennas and/or one or more transceivers (e.g., wireless transceiver(s)).

At block 1302, the computing device (or component thereof) can generate, using a generator of a machine learning model (e.g., the generator 810 of FIG. 8, the generator 910 of FIG. 9, or the generator 1010 of FIG. 10) based on a noise input, a plurality of candidate avatars. In some cases, the machine learning model can include a neural network. In some aspects, the noise input is based on random noise (the random noise 860 of FIG. 8, the random noise 960 of FIG. 9, or the random noise 1060 of FIG. 10).

At block 1304, the computing device (or component thereof) can modify, based on at least one of user preferences of a user for features of an avatar (e.g., based on the owner priority 825 of FIG. 8, the owner priority 925, the dataset of user's albums 965, and the dataset of user sentiments 975 of FIG. 9, or the dataset of user's albums 1065 and the dataset of user sentiments 1075 of FIG. 10) or popularity of available avatars (e.g., based on the popularity weights 835 of FIG. 8, the popularity weights 935 of FIG. 9, etc.), an initial dataset of avatars to generate a modified dataset of avatars (e.g., the modified dataset described with respect to FIG. 8, FIG. 9, or FIG. 10). In some examples, at least one avatar of the initial dataset of avatars is based on a character in a game. In some aspects, the user preferences are based on images associated with the user and/or social media posts associated with the user. In some cases, the user preferences for features of the avatar include a type of clothing, a color of the clothing, a type of hair, a color of the hair, one or more facial features, an attitude, a behavior, any combination thereof, and/or other preferences. In some aspects, the user preferences are based on prompt-based weighting for user priority (e.g., the owner prompt 1025 of FIG. 10). In some cases, the user preferences are tracked by an additional machine learning model (e.g., an additional neural network, such as the owner preferences neural network 945 of FIG. 9). In some cases, the popularity of the available avatars is tracked on a website and/or a game platform by an additional machine learning model (e.g., an additional neural network, such as the tracker neural network 955 of FIG. 9).

At block 1306, the computing device (or component thereof) can compare, using a discriminator of the machine learning model (e.g., the discriminator 820 of FIG. 8, the discriminator 920 of FIG. 9, or the discriminator 1020 of FIG. 10), each candidate avatar of the plurality of candidate avatars with avatars in the modified dataset of avatars. In some aspects, the generator and the discriminator are part of a generative adversarial network (GAN).

At block 1308, the computing device (or component thereof) can determine, using the discriminator based on the comparing, whether each candidate avatar of the plurality of candidate avatars belongs in the modified dataset of avatars. In some aspects, the computing device (or component thereof) can generate, using the discriminator based on the comparing, for each candidate avatar of the plurality of candidate avatars, a respective probability associated with belonging in the modified dataset of avatars, as described with respect to FIG. 8, FIG. 9, and FIG. 10. In some aspects, the computing device (or component thereof) can select, based on determining a candidate avatar of the plurality of candidate avatars belongs in the modified dataset of avatars, the plurality of candidate avatars for use by the user.

In some aspects, the computing device (or component thereof) can train, based on the modified dataset of avatars, the discriminator to determine whether each candidate avatar of the plurality of candidate avatars belongs in the modified dataset of avatars. In some cases, the computing device (or component thereof) can generate, during the training of the discriminator, a discriminator loss (e.g., the discriminator loss 890 of FIG. 8, the discriminator loss 990 of FIG. 9, or the discriminator loss 1090 of FIG. 10) based on an accuracy of the discriminator to determine (e.g., how accurate the discriminator is in determining) whether each candidate avatar of the plurality of candidate avatars belongs in the modified dataset of avatar. In some aspects, the computing device (or component thereof) can modify, based on historical usage of avatars by the user (e.g., the owner historical usage 875 of FIG. 8), the discriminator loss to generate a modified discriminator loss. In some examples, the computing device (or component thereof) can tune, based on the modified discriminator loss, neural network weights of the discriminator.

In some aspects, the computing device (or component thereof) can train, based on the modified dataset of avatars, the generator to generate the plurality of candidate avatars to belong in the modified dataset of avatars. In some cases, the computing device (or component thereof) can generate, during the training of the generator, a generator loss (e.g., the generator loss 880 of FIG. 8, the generator loss 980 of FIG. 9, or the generator loss 1080 of FIG. 10) based on an ability of the generator to generate (e.g., how accurate the generator is in generating) the plurality of candidate avatars to belong in the modified dataset of avatars. In some aspects, the computing device (or component thereof) can modify, based on historical usage of avatars by the user (e.g., the owner historical usage 875 of FIG. 8), the generator loss to generate a modified generator loss. In some cases, the computing device (or component thereof) can tune, based on the modified generator loss, neural network weights of the generator.

In some cases, the computing device of process 1300 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 1300 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1300 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1300 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 14 is a block diagram illustrating an example of a computing system 1400, which may be employed for the generation of skins and avatars using user priority and popularity weights. In particular, FIG. 14 illustrates an example of computing system 1400, which can be for example any computing device making up internal computing system, a remote computing system, a camera, or any component thereof in which the components of the system are in communication with each other using connection 1405. Connection 1405 can be a physical connection using a bus, or a direct connection into processor 1410, such as in a chipset architecture. Connection 1405 can also be a virtual connection, networked connection, or logical connection.

In some aspects, computing system 1400 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1400 includes at least one processing unit (CPU or processor) 1410 and connection 1405 that communicatively couples various system components including system memory 1415, such as read-only memory (ROM) 1420 and random access memory (RAM) 1425 to processor 1410. Computing system 1400 can include a cache 1412 of high-speed memory connected directly with, in close proximity to, or integrated as part of processor 1410.

Processor 1410 can include any general purpose processor and a hardware service or software service, such as services 1432, 1434, and 1436 stored in storage device 1430, configured to control processor 1410 as well as a special-purpose processor where software instructions are incorporated into the actual processor design. Processor 1410 may essentially be a completely self-contained computing system, containing multiple cores or processors, a bus, memory controller, cache, etc. A multi-core processor may be symmetric or asymmetric.

To enable user interaction, computing system 1400 includes an input device 1445, which can represent any number of input mechanisms, such as a microphone for speech, a touch-sensitive screen for gesture or graphical input, keyboard, mouse, motion input, speech, etc. Computing system 1400 can also include output device 1435, which can be one or more of a number of output mechanisms. In some instances, multimodal systems can enable a user to provide multiple types of input/output to communicate with computing system 1400.

Computing system 1400 can include communications interface 1440, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1440 may also include one or more range sensors (e.g., LiDAR sensors, laser range finders, RF radars, ultrasonic sensors, and infrared (IR) sensors) configured to collect data and provide measurements to processor 1410, whereby processor 1410 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1440 may also include one or more receivers or transceivers that are used to determine a location of the computing system 1400 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1430 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1430 can include software services, servers, services, etc., that when the code that defines such software is executed by the processor 1410, it causes the system to perform a function. In some aspects, a hardware service that performs a particular function can include the software component stored in a computer-readable medium in connection with the necessary hardware components, such as processor 1410, connection 1405, output device 1435, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. An apparatus for generating avatars, the apparatus comprising: at least one memory; and at least one processor coupled to the at least one memory and configured to: generate, using a generator of a machine learning model based on a noise input, a plurality of candidate avatars; modify, based on at least one of user preferences of a user for features of an avatar or popularity of available avatars, an initial dataset of avatars to generate a modified dataset of avatars; compare, using a discriminator of the machine learning model, each candidate avatar of the plurality of candidate avatars with avatars in the modified dataset of avatars; and determine, using the discriminator based on the comparing, whether each candidate avatar of the plurality of candidate avatars belongs in the modified dataset of avatars.

Aspect 2. The apparatus of Aspect 1, wherein the at least one processor is configured to generate, using the discriminator based on the comparing, for each candidate avatar of the plurality of candidate avatars a respective probability associated with belonging in the modified dataset of avatars.

Aspect 3. The apparatus of any of Aspects 1 or 2, wherein the noise input is based on random noise.

Aspect 4. The apparatus of any of Aspects 1 to 3, wherein the at least one processor is configured to: train, based on the modified dataset of avatars, the discriminator to determine whether each candidate avatar of the plurality of candidate avatars belongs in the modified dataset of avatars; and generate, during the training of the discriminator, a discriminator loss based on an accuracy of the discriminator to determine whether each candidate avatar of the plurality of candidate avatars belongs in the modified dataset of avatar.

Aspect 5. The apparatus of Aspect 4, wherein the at least one processor is configured to modify, based on historical usage of avatars by the user, the discriminator loss to generate a modified discriminator loss.

Aspect 6. The apparatus of Aspect 5, wherein the at least one processor is configured to tune, based on the modified discriminator loss, neural network weights of the discriminator.

Aspect 7. The apparatus of any of Aspects 1 to 6, wherein the at least one processor is configured to: train, based on the modified dataset of avatars, the generator to generate the plurality of candidate avatars to belong in the modified dataset of avatars; and generate, during the training of the generator, a generator loss based on an ability of the generator to generate the plurality of candidate avatars to belong in the modified dataset of avatars.

Aspect 8. The apparatus of Aspect 7, wherein the at least one processor is configured to modify, based on historical usage of avatars by the user, the generator loss to generate a modified generator loss.

Aspect 9. The apparatus of Aspect 8, wherein the at least one processor is configured to tune, based on the modified generator loss, neural network weights of the generator.

Aspect 10. The apparatus of any of Aspects 1 to 9, wherein the user preferences are based on at least one of images associated with the user or social media posts associated with the user.

Aspect 11. The apparatus of any of Aspects 1 to 10, wherein the user preferences are tracked by an additional machine learning model.

Aspect 12. The apparatus of any of Aspects 1 to 11, wherein the popularity of the available avatars is tracked on at least one of a website or a game platform by an additional machine learning model.

Aspect 13. The apparatus of any of Aspects 1 to 12, wherein the user preferences for features of the avatar comprise at least one of a type of clothing, a color of the clothing, a type of hair, a color of the hair, one or more facial features, an attitude, or a behavior.

Aspect 14. The apparatus of any of Aspects 1 to 13, wherein the user preferences are based on prompt-based weighting for user priority.

Aspect 15. The apparatus of any of Aspects 1 to 14, wherein the at least one processor is configured to select, based on determining a candidate avatar of the plurality of candidate avatars belongs in the modified dataset of avatars, the plurality of candidate avatars for use by the user.

Aspect 16. The apparatus of any of Aspects 1 to 15, wherein the generator and the discriminator are part of a generative adversarial network (GAN).

Aspect 17. The apparatus of any of Aspects 1 to 16, wherein the machine learning model is a neural network.

Aspect 18. The apparatus of any of Aspects 1 to 17, wherein at least one avatar of the initial dataset of avatars is based on a character in a game.

Aspect 19. A method for generating avatars, the method comprising: generating, by a generator of a machine learning model based on a noise input, a plurality of candidate avatars; modifying, based on at least one of user preferences of a user for features of an avatar or popularity of available avatars, an initial dataset of avatars to generate a modified dataset of avatars; comparing, by a discriminator of the machine learning model, each candidate avatar of the plurality of candidate avatars with avatars in the modified dataset of avatars; and determining, by the discriminator based on the comparing, whether each candidate avatar of the plurality of candidate avatars belongs in the modified dataset of avatars.

Aspect 20. The method of Aspect 19, further comprising generating, by the discriminator based on the comparing, for each candidate avatar of the plurality of candidate avatars a respective probability associated with belonging in the modified dataset of avatars.

Aspect 21. The method of any of Aspects 19 or 20, wherein the noise input is based on random noise.

Aspect 22. The method of any of Aspects 19 to 21, further comprising: training, based on the modified dataset of avatars, the discriminator to determine whether each candidate avatar of the plurality of candidate avatars belongs in the modified dataset of avatars; and generating, during the training of the discriminator, a discriminator loss based on an accuracy of the discriminator to determine whether each candidate avatar of the plurality of candidate avatars belongs in the modified dataset of avatar.

Aspect 23. The method of Aspect 22, further comprising modifying, based on historical usage of avatars by the user, the discriminator loss to generate a modified discriminator loss.

Aspect 24. The method of Aspect 23, further comprising tuning, based on the modified discriminator loss, neural network weights of the discriminator.

Aspect 25. The method of any of Aspects 19 to 24, further comprising: training, based on the modified dataset of avatars, the generator to generate the plurality of candidate avatars to belong in the modified dataset of avatars; and generating, during the training of the generator, a generator loss based on an ability of the generator to generate the plurality of candidate avatars to belong in the modified dataset of avatars.

Aspect 26. The method of Aspect 25, further comprising modifying, based on historical usage of avatars by the user, the generator loss to generate a modified generator loss.

Aspect 27. The method of Aspect 26, further comprising tuning, based on the modified generator loss, neural network weights of the generator.

Aspect 28. The method of any of Aspects 19 to 27, wherein the user preferences are based on at least one of images associated with the user or social media posts associated with the user.

Aspect 29. The method of any of Aspects 19 to 28, wherein the user preferences are tracked by an additional machine learning model.

Aspect 30. The method of any of Aspects 19 to 29, wherein the popularity of the available avatars is tracked on at least one of a website or a game platform by an additional machine learning model.

Aspect 31. The method of any of Aspects 19 to 30, wherein the user preferences for features of the avatar comprise at least one of a type of clothing, a color of the clothing, a type of hair, a color of the hair, one or more facial features, an attitude, or a behavior.

Aspect 32. The method of any of Aspects 19 to 31, wherein the user preferences are based on prompt-based weighting for user priority.

Aspect 33. The method of any of Aspects 19 to 32, further comprising selecting, based on determining a candidate avatar of the plurality of candidate avatars belongs in the modified dataset of avatars, the plurality of candidate avatars for use by the user.

Aspect 34. The method of any of Aspects 19 to 33, wherein the generator and the discriminator are part of a generative adversarial network (GAN).

Aspect 35. The method of any of Aspects 19 to 34, wherein the machine learning model is a neural network.

Aspect 36. The method of any of Aspects 19 to 35, wherein at least one avatar of the initial dataset of avatars is based on a character in a game.

Aspect 37. A non-transitory computer-readable medium having stored thereon instructions that, when executed by at least one processor, cause the at least one processor to perform operations according to any of Aspects 19 to 36.

Aspect 38. An apparatus for generating avatars, the apparatus including one or more means for performing operations according to any of Aspects 19 to 36.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus for generating avatars, the apparatus comprising:
at least one memory; and
at least one processor coupled to the at least one memory and configured to:
generate, using a generator of a machine learning model based on a noise input, a plurality of candidate avatars;
modify, based on at least one of user preferences of a user for features of an avatar or popularity of available avatars, an initial dataset of avatars to generate a modified dataset of avatars;
compare, using a discriminator of the machine learning model, each candidate avatar of the plurality of candidate avatars with avatars in the modified dataset of avatars; and
determine, using the discriminator based on the comparing, whether each candidate avatar of the plurality of candidate avatars belongs in the modified dataset of avatars.

2. The apparatus of claim 1, wherein the at least one processor is configured to generate, using the discriminator based on the comparing, for each candidate avatar of the plurality of candidate avatars a respective probability associated with belonging in the modified dataset of avatars.

3. The apparatus of claim 1, wherein the noise input is based on random noise.

4. The apparatus of claim 1, wherein the at least one processor is configured to:
train, based on the modified dataset of avatars, the discriminator to determine whether each candidate avatar of the plurality of candidate avatars belongs in the modified dataset of avatars; and
generate, during the training of the discriminator, a discriminator loss based on an accuracy of the discriminator to determine whether each candidate avatar of the plurality of candidate avatars belongs in the modified dataset of avatar.

5. The apparatus of claim 4, wherein the at least one processor is configured to modify, based on historical usage of avatars by the user, the discriminator loss to generate a modified discriminator loss.

6. The apparatus of claim 5, wherein the at least one processor is configured to tune, based on the modified discriminator loss, neural network weights of the discriminator.

7. The apparatus of claim 1, wherein the at least one processor is configured to:
train, based on the modified dataset of avatars, the generator to generate the plurality of candidate avatars to belong in the modified dataset of avatars; and
generate, during the training of the generator, a generator loss based on an ability of the generator to generate the plurality of candidate avatars to belong in the modified dataset of avatars.

8. The apparatus of claim 7, wherein the at least one processor is configured to modify, based on historical usage of avatars by the user, the generator loss to generate a modified generator loss.

9. The apparatus of claim 8, wherein the at least one processor is configured to tune, based on the modified generator loss, neural network weights of the generator.

10. The apparatus of claim 1, wherein the user preferences are based on at least one of images associated with the user or social media posts associated with the user.

11. The apparatus of claim 1, wherein the user preferences are tracked by an additional machine learning model.

12. The apparatus of claim 1, wherein the popularity of the available avatars is tracked on at least one of a website or a game platform by an additional machine learning model.

13. The apparatus of claim 1, wherein the user preferences for features of the avatar comprise at least one of a type of clothing, a color of the clothing, a type of hair, a color of the hair, one or more facial features, an attitude, or a behavior.

14. The apparatus of claim 1, wherein the user preferences are based on prompt-based weighting for user priority.

15. The apparatus of claim 1, wherein the at least one processor is configured to select, based on determining a candidate avatar of the plurality of candidate avatars belongs in the modified dataset of avatars, the plurality of candidate avatars for use by the user.

16. The apparatus of claim 1, wherein the generator and the discriminator are part of a generative adversarial network (GAN).

17. The apparatus of claim 1, wherein the machine learning model is a neural network.

18. The apparatus of claim 1, wherein at least one avatar of the initial dataset of avatars is based on a character in a game.

19. A method for generating avatars, the method comprising:
generating, by a generator of a machine learning model based on a noise input, a plurality of candidate avatars;
modifying, based on at least one of user preferences of a user for features of an avatar or popularity of available avatars, an initial dataset of avatars to generate a modified dataset of avatars;
comparing, by a discriminator of the machine learning model, each candidate avatar of the plurality of candidate avatars with avatars in the modified dataset of avatars; and
determining, by the discriminator based on the comparing, whether each candidate avatar of the plurality of candidate avatars belongs in the modified dataset of avatars.

20. The method of claim 19, further comprising selecting, based on determining a candidate avatar of the plurality of candidate avatars belongs in the modified dataset of avatars, the plurality of candidate avatars for use by the user.
